(19) United States
(12) Patent Application Publication
(10) Pub. No.: US 2025/0167337 A1
(43) Pub. Date: May 22, 2025

(54) MULTIFUNCTIONAL LITHIUM-ION BATTERY PROTECTION

(71) Applicant: Florida State University Research Foundation, Inc., Tallahassee, FL (US)

(72) Inventors: Farhad Farzaneh, Tallahassee, FL (US); Sungmoon Jung, Tallahassee, FL (US)

(21) Appl. No.: 18/952,476

(22) Filed: Nov. 19, 2024

Related U.S. Application Data
(60) Provisional application No. 63/601,317, filed on Nov. 21, 2023.

(51) Int. Cl. H01M 10/6552; H01M 10/625; H01M 10/659; H01M 50/242

(52) U.S. Cl. CPC H01M 10/6552; H01M 10/625; H01M 10/659; H01M 50/242

(57) ABSTRACT

Systems and methods for protecting batteries (e.g., lithium ion batteries, such as electric vehicle (EV) batteries) are provided. Multifunctional battery protection systems and methods provide efficient heat dissipation and effective energy absorption. Designed tubes can be integrated and/or filled with a phase change material (PCM), thereby significantly enhancing the safety and performance of batteries, such as EV batteries, under various operating conditions.

### CROSS-REFERENCE TO RELATED APPLICATION

This application claims the benefit of U.S. Provisional Application Ser. No. 63/601,317, filed Nov. 21, 2023, the disclosure of which is hereby incorporated by reference in its entirety, including all figures, tables, and drawings.

### BACKGROUND

When an electric vehicle (EV) is involved in a crash or other significant impact, the battery system of the EV can cause substantial damage. Existing systems for protecting batteries and battery systems all have significant drawbacks.

### BRIEF SUMMARY

Embodiments of the subject invention provide novel and advantageous systems and methods for protecting batteries (e.g., lithium-ion batteries, such as electric vehicle (EV) batteries). Multifunctional battery protection systems and methods of embodiments of the subject invention provide efficient heat dissipation and effective energy absorption. Designed tubes can be integrated and/or filled with a phase change material (PCM), thereby significantly enhancing the safety and performance of batteries, such as EV batteries, under various operating conditions.

In an embodiment, a system for protecting batteries (e.g., EV batteries) (or battery cells) and/or dissipating heat from batteries can comprise a plurality of tubes disposed around the batteries, respectively, and each tube of the plurality of tubes can comprise a PCM disposed therein. Each tube of the plurality of tubes can comprise a first cap on a first end thereof and/or a second cap on a second end thereof. The first cap can comprise at least one first orifice (e.g., a plurality of first orifices, such as at least four first orifices or exactly four first orifices). A largest dimension of each first orifice can be in a range of, for example, from 0.2 millimeters (mm) to 6 mm. The second cap can comprise at least one second orifice (e.g., a plurality of second orifices, such as at least four second orifices or exactly four second orifices). A largest dimension of each second orifice can be in a range of, for example, from 0.2 mm to 6 mm. Each tube of the plurality of tubes can comprise aluminum. Each tube of the plurality of tubes can be a cylindrical-shaped tube (e.g., having a circular cross-section). Each tube of the plurality of tubes can be completely filled with the PCM in an axial direction of the tube (and/or completely filled with PCM around the battery in a radial direction of the tube). A thickness of a wall of each tube of the plurality of tubes can be, for example, less than 10% of a diameter of said tube. A thickness of each tube of the plurality of tubes can be in a range of, for example, from 1.5 mm to 4 mm. A diameter of each tube of the plurality of tubes is in a range of, for example, from 45 mm to 60 mm.

In another embodiment, a system for protecting batteries (e.g., EV batteries) (or battery cells) and/or dissipating heat from batteries can comprise a plurality of tubes configured to be disposed around the batteries, respectively; each tube of the plurality of tubes can comprise a PCM disposed therein; and the PCM can comprise a paraffin-graphite (e.g., paraffin wax and expanded graphite) composite. A weight ratio of graphite:paraffin in the PCM can be in a range of from 1:5 to 1:25, such as 1:15 or about 1:15. Each tube of the plurality of tubes can comprise a first cap on a first end thereof and/or a second cap on a second end thereof. The first cap can comprise at least one first orifice (e.g., a plurality of first orifices, such as at least four first orifices or exactly four first orifices). A largest dimension of each first orifice can be in a range of, for example, from 0.2 millimeters (mm) to 6 mm. The second cap can comprise at least one second orifice (e.g., a plurality of second orifices, such as at least four second orifices or exactly four second orifices). A largest dimension of each second orifice can be in a range of, for example, from 0.2 mm to 6 mm. Each tube of the plurality of tubes can comprise aluminum. Each tube of the plurality of tubes can be a cylindrical-shaped tube (e.g., having a circular cross-section). Each tube of the plurality of tubes can be completely filled with the PCM in an axial direction of the tube (and/or completely filled with PCM around the battery in a radial direction of the tube). A thickness of a wall of each tube of the plurality of tubes can be, for example, less than 10% of a diameter of said tube. A thickness of each tube of the plurality of tubes can be in a range of, for example, from 1.5 mm to 4 mm. A diameter of each tube of the plurality of tubes is in a range of, for example, from 45 mm to 60 mm.

In another embodiment, a method for protecting a battery pack (e.g., an EV battery pack) can comprise: providing a system as disclosed herein; and disposing the plurality of tubes around batteries, respectively, of the battery pack. The plurality of tubes can be disposed such that the PCM of each tube is in direct physical contact with the respective battery around which the tube is disposed.

In another embodiment, a method for dissipating heat from a battery pack (e.g., an EV battery pack) can comprise: providing a system as disclosed herein; and disposing the plurality of tubes around batteries, respectively, of the battery pack. The plurality of tubes can be disposed such that the PCM of each tube is in direct physical contact with the respective battery around which the tube is disposed.

In another embodiment, an EV can comprise: a battery pack; and a system as disclosed herein in which the tubes are disposed around batteries, respectively, of the battery pack. The PCM of each tube can be in direct physical contact with the respective battery around which the tube is disposed.

### BRIEF DESCRIPTION OF DRAWINGS

FIG. 1 shows an image of an experimental test setup.

FIG. 2a shows images of tubes that can be used with embodiments of the subject invention, before being filled with phase change material (PCM). Though FIG. 2a lists certain dimensions, these are for exemplary purposes only and should not be construed as limiting.

FIG. 2b shows images of the tubes from FIG. 2a, after being filled with PCM (24 hours after filling).

FIG. 2c shows images of tubes that can be used with embodiments of the subject invention, before being filled with phase change material (PCM). Though FIG. 2c lists certain dimensions, these are for exemplary purposes only and should not be construed as limiting.

FIG. 2d shows images of the tubes from FIG. 2c, after being filled with PCM.

FIGS. 3a-3d show images of sample preparation for an experiment. FIG. 3a shows paraffin wax; FIG. 3b shows chamber temperature settings; FIG. 3c shows an MTS 651 environmental chamber; and FIG. 3d shows melted paraffin wax.

FIG. 4a shows an image of a PCM-filled tube.

FIG. 4b shows the tube of FIG. 4a after being indented.

FIG. 5 shows a plot of force (in kiloNewtons (kN)) versus displacement (in millimeters (mm)), showing a comparison of load-deflection responses of special empty and filled tubes. The (green) curve with the highest force value at a displacement of 20 mm is for closed (simulated); the (blue) curve with the second-highest force value at a displacement of 20 mm is for approximate closed; the (red) curve with the third-highest force value at a displacement of 20 mm is for filled; the (yellow) curve with the second-lowest force value at a displacement of 20 mm is for empty; and the (purple) curve with the lowest force value at a displacement of 20 mm is for open. All curves are for containers with a thickness (T) of 3.175 mm and a diameter (D) of 50.8 mm.

FIG. 6 shows a plot of force (in kN) versus displacement (in mm), showing force-displacement of samples in accordance with SCD. The solid (green) curve with the highest force value at a displacement of 20 mm is for T=3.175 mm, D=50.8 mm, and an orifice size (d) of 3 mm; the solid (red) curve with the second-highest force value at a displacement of 20 mm is for T=3.175 mm, D=44.45 mm, and d=3 mm; the solid (blue) curve with the third-highest force value at a displacement of 20 mm is for T=3.175 mm, D=44.45 mm, and d=6 mm; the solid (yellow) curve with the fourth-highest force value at a displacement of 20 mm is for T=3.175 mm, D=50.8 mm, and d=6 mm; the dashed (green) curve with the fifth-highest force value at a displacement of 20 mm is for T=1.651 mm, D=50.8 mm, and d=3 mm; the dashed (red) curve with the sixth-highest force value at a displacement of 20 mm is for T=1.651 mm, D=44.45 mm, and d=3 mm; the dashed (yellow) curve with the second-lowest force value at a displacement of 20 mm is for T=1.651 mm, D=50.8 mm, and d=6 mm; and the dashed (blue) curve with the lowest force value at a displacement of 20 mm is for T=1.651 mm, D=44.45 mm, and d=6 mm.

FIG. 7 shows plots of, from left to right: specific energy (SE) (in Joules per gram (J/gr)) versus thickness (in mm); SE (in J/gr) versus diameter (in mm); and SE (in J/gr) versus orifice size (in mm). These three plots show the effect of geometrical parameters on SE absorption.

FIG. 8 shows a plot of absorbed energy (in J) versus sample mass (in gr), showing variation of absorbed energy by sample mass.

FIG. 9a shows a finite element (FE) model of a PCM-filled tube.

FIG. 9b shows a discretized model of samples of a PCM-filled tube under dynamic impact loading.

FIG. 9c shows a discretized model of a cross-sectional view of the tube in FIG. 9b.

FIG. 10 shows a plot of absorbed energy (in J) versus number of shell elements (in ten thousands), showing results of a tube mesh convergence study.

FIG. 11 shows a plot of absorbed energy (in J) versus number of smoothed-particle hydrodynamics (SPH) nodes (in ten thousands), showing results of an SPH seeds convergence study.

FIG. 12a shows images of an empty tube (left image) and a PCM-filled tube (right image) in an experimental setup.

FIG. 12b shows simulation results for an empty tube (left two images) and PCM-filled tube (right two images).

FIG. 13a shows a plot of force (in kN) versus displacement (in mm) for an empty tube under indentation. The (red) curve with the higher force value at a displacement of 5 mm is for the values simulated using LS-Dyna software; and the (blue) curve with the lower force value at a displacement of 5 mm is for the experimental results.

FIG. 13b shows a plot of force (in kN) versus displacement (in mm) for a filled tube under indentation. The (red) curve with the higher force value at a displacement of 5 mm is for the values simulated using LS-Dyna software; and the (blue) curve with the lower force value at a displacement of 5 mm is for the experimental results.

FIG. 14 shows a plot of force (in kN) versus displacement (in mm), showing the effect of geometrical parameters over the mass on SE. The (red) curve with the highest force value at a displacement of 20 mm is for T=1.816 mm, D=50.8 mm, and d=6 mm; the (yellow) curve with the second-highest force value at a displacement of 20 mm is for T=1.651 mm, D=50.8 mm, and d=6 mm; and the (blue) curve with the lowest force value at a displacement of 20 mm is for T=1.651 mm, D=54.64 mm, and d=6 mm.

FIG. 15 shows a plot of absorbed energy (in J) versus u (which is a function of T, D, and d), showing energy absorption versus geometrical parameters.

FIG. 16 shows a plot of normalized SE versus normalized change percentage. The (red) curve labeled “T: 1.651, d: 3” shows effect of D (where T=1.651 mm and d=3 mm); the (yellow) curve labeled “T: 1.651, D: 44.45” shows effect of d (where T=1.651 mm and D=44.45 mm); and the (blue) curve labeled “D: 44.45, d: 3” shows effect of T (where D=44.45 mm and d=3 mm).

FIG. 17 shows variation of SE absorption with geometrical parameters. The axes show d, T, and D (all in mm).

FIG. 18a shows a schematic view of indented circular tube along hinge lines; and FIG. 18b shows a cross-sectional view of the indented circular tube from FIG. 18a (see also Lu and Yu, Energy absorption of structures and materials, Elsevier, 2003; which is hereby incorporated by reference herein in its entirety).

FIG. 19 shows a plot of force (in kN) versus displacement (in mm), showing experimental, numerical, and analytical force-displacement results for an empty tube with T=3.175 mm and D=50.8 mm. The (yellow) curve with the highest force value at a displacement of 15 mm is for the analytical approach; the (red) curve with the second-highest force value at a displacement of 15 mm is for the numerical approach; and the (blue) curve with the lowest force value at a displacement of 15 mm is for the experimental approach.

FIG. 20 shows a plot of force (in kN) versus displacement (in mm), showing experimental, numerical, and analytical force-displacement results for a filled tube with T=3.175 mm, D=50.8 mm, and d=6 mm. The (red) curve with the highest force value at a displacement of 5 mm is for the numerical approach; the (blue) curve with the second-highest force value at a displacement of 5 mm is for the experimental approach; and the (yellow) curve with the lowest force value at a displacement of 5 mm is for the numerical approach.

FIG. 21 shows a table of mechanical properties of aluminum 6061 T6 (A1 6061-T6) alloy.

FIG. 22 shows a table of systematic case design (SCD) and number of samples for an experiment.

FIG. 23 shows a table of comparison of absorbed energy at the end of deflection.

FIG. 24 shows a table of a comparison of absorbed energy of samples in accordance with SCD.

FIG. 25 shows a table of variables in the Johnson-Cook material model that apply to Al 6061-T6 alloy (see also Lesuer et al., Modeling large-strain, high-rate deformation in 507 metals, Lawrence Livermore National Lab (LLNL), Livermore, CA (United States), 2001; which is hereby incorporated by reference herein in its entirety).

FIG. 26 shows a table of variables in the NULL material model and the Gruneisen equation of state (EOS) that apply to PCM material (see also Kamioka, Ultrasonic Behaviour of Paraffin Wax during Melting and Solidification 509 Processes, Jpn. J. Appl. Phys., vol. 33, no. 5S, p. 2908, 1994; which is hereby incorporated by reference herein in its entirety).

FIG. 27 shows a table of the effect of geometrical parameters over the mass on SE.

FIG. 28 shows a table of an energy absorption comparison between an experimental approach, a numerical approach, and an analytical approach.

FIG. 29 shows a table of a comparison of energy absorption and SE absorption with different approaches.

FIG. 30a shows a battery cell disposed inside a tube (with PCM), according to an embodiment of the subject invention.

FIG. 30b shows a cross-sectional view of the tube and battery cell from FIG. 30a, taken along the dashed line A-A′ in FIG. 30a.

FIG. 31 shows a battery pack with an array of battery cells each disposed in a tube (with PCM), according to an embodiment of the subject invention.

FIG. 32 shows a table of sample specifications for a systematic case design of sampling.

FIG. 33 shows a table of the chemical composition of ASTM B210 Aluminum 6061 T6

FIG. 34 shows an image of residual deflection after impact on representative test samples.

FIG. 35 shows a table of experimental and calculation results.

FIG. 36 shows a plot of acceleration (in g's (gravity)) versus time (in milliseconds (ms)), showing an impactor acceleration history pattern.

FIG. 37a shows a plot of velocity (in millimeters per millisecond (mm/ms)) versus time (in ms) for a sample.

FIG. 37b shows a plot of impact tip location (in mm) versus time (in ms) for the sample from FIG. 37a.

FIG. 37c shows a plot of force (in kilonewtons (kN)) versus displacement (in millimeters (mm)) for the sample from FIGS. 37a and 37b.

FIG. 38a shows a plot of force (in kN) versus displacement (in mm) showing experimental results for selected samples.

FIG. 38b shows a plot of impact tip location (in mm) versus time (in ms) showing experimental results for selected samples.

FIG. 39a shows a plot of force (in kN) versus displacement (in mm) showing experimental results for main samples.

FIG. 39b shows a plot of impact tip location (in mm) versus time (in ms) showing experimental results for main samples.

FIGS. 40a-40c show plots of residual space (in mm) versus thickness (in mm), residual space (in mm) versus diameter (mm), and residual space (in mm) versus orifice size (in mm), showing effect of geometrical parameters on residual space.

FIGS. 40d-40f show plots of maximum displacement (in mm) versus thickness (in mm), maximum displacement (in mm) versus diameter (mm), and maximum displacement (in mm) versus orifice size (in mm), showing effect of geometrical parameters on maximum displacement/deflection.

FIG. 41a shows a plot of change in peak acceleration (in g's) versus parameter increase (10%) for main samples.

FIG. 41b shows a plot of change in impact duration (in ms) versus parameter increase (10%) for main samples.

FIG. 42 shows a bar chart of absorbed energy percentage (%) for different parameters. In each of the two groupings, the left-most bar is for thickness (T), the middle bar is for diameter (D), and the right-most bar is for orifice size (d).

FIG. 43 shows a table of 18,650 lithium ion battery (LIB) specifications.

FIG. 44a shows a plot of temperature (in ° C.) versus time (in seconds(s)) for unprotected batteries.

FIG. 44b shows a plot of voltage (in Volts (V)) versus time (in s) for unprotected batteries.

FIG. 45a shows a plot of temperature (in ° C.) versus time (in s) for protected batteries. FIG. 45b shows a plot of voltage (in V) versus time (in s) for protected batteries.

FIG. 46 shows a plot of temperature (in ° C.) versus time (in s) for composite PCM in 1 C and 2 C discharging rates.

FIG. 47a shows a plot of maximum displacement versus number of shell elements for a tube.

FIG. 47b shows a plot of maximum displacement versus number of smoothed-particle hydrodynamics (SPH) nodes for a PCM mesh convergence study.

FIG. 48 shows a table of Johnson Cook (JC) material model variables for aluminum 6061 T6.

FIG. 49 shows a table of null material model variables for paraffin wax.

FIGS. 50a and 50b shows plots of force (in kN) versus displacement (in mm), showing a comparison between numerical and experimental results for 1.651-50.8-vacant capped tubes and for 1.651-44.45-6 tubes, respectively.

FIG. 51 shows a table of energy absorption results.

FIG. 52 shows a plot of maximum deflection (δmax) versus gamma (γ; a function of T, D, and d).

FIG. 53 shows a plot of maximum deflection (δmax) versus normalized parameter values. The curve with the highest δmax values is for d; the curve with the second-highest δmax values is for D; and the curve with the lowest δmax values is for T.

FIG. 54 shows change in maximum deflection based on T, D, and d.

FIGS. 55a and 55b show plots of force (in kN) versus displacement (in mm) for a 18,650 battery cell under an indentation test and under a compression test, respectively.

FIG. 56 shows a table of mechanical properties used in a simulation.

FIG. 57 shows a perspective view of battery pack components and an armor shield (see also, Xia et al., Damage of cells and battery packs due to ground impact, J. Power Sources 267, 78-97, 2014; which is hereby incorporated herein by reference in its entirety).

FIG. 58 shows a plot of force (in kN) versus displacement (in mm) for contact force on an impactor.

FIG. 59a shows visual validation of a simulation in LS-Dyna.

FIG. 59b shows a simulation in LS-Dyna (see also Xia et al., supra.).

FIG. 60a shows an 18,650 battery cell integrated in a sample (3.175-50.8-3).

FIG. 60b shows a cross-sectional view of the battery cell in FIG. 60a.

FIG. 61a shows a cross-section of a sample at the onset of maximum deflection.

FIG. 61b shows a plot of absolute change in length (in mm) versus time (in ms), showing distance of two nodes on ends of a cross-section diameter.

FIG. 62 shows an overhead view of a car, showing side pole crash conditions in accordance with FMVSS214.

FIG. 63a shows LIB cells protected, according to an embodiment of the subject invention. These are protected with 3.175-50.8-3-filled-capped tubes, though other parameters could be used.

FIG. 63b shows the LIB cells from FIG. 63a in an unprotected state.

FIG. 64a shows an overhead view of a deformed vehicle under side-pole impact.

FIG. 64b shows an overhead view of a deflected battery module from the impact shown in FIG. 64a, protected according to an embodiment of the subject invention.

FIG. 64c shows an overhead view of a deflected battery module from the impact shown in FIG. 64a, the battery module being unprotected.

FIG. 65 shows a plot of change in diameter length (in mm) versus time (in ms), showing results from the impact from FIGS. 64a-64c for protected and unprotected batteries. The upper curve in the plot is for protected battery, and the curve in the lower part of the plot is for unprotected battery.

### DETAILED DESCRIPTION

Embodiments of the subject invention provide novel and advantageous systems and methods for protecting batteries (e.g., lithium-ion batteries, such as electric vehicle (EV) batteries). Multifunctional battery protection systems and methods of embodiments of the subject invention provide efficient heat dissipation and effective energy absorption. Designed tubes can be integrated and/or filled with a phase change material (PCM), thereby significantly enhancing the safety and performance of batteries, such as EV batteries, under various operating conditions.

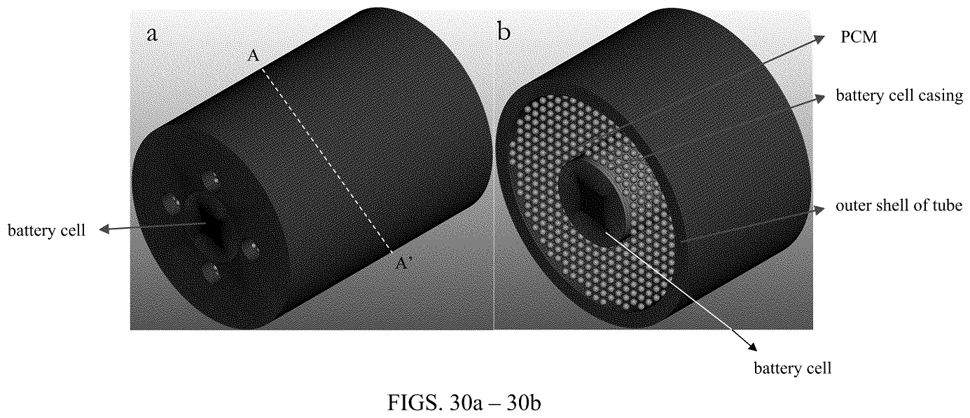

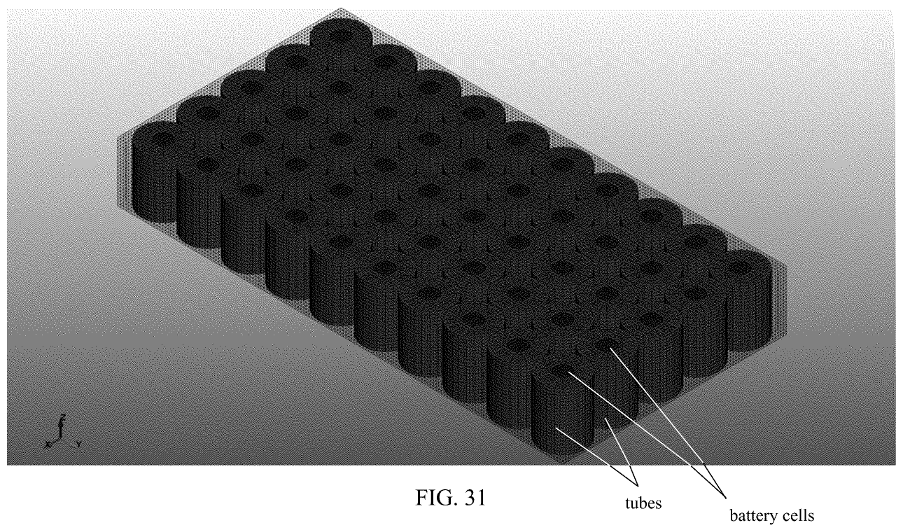

The PCM-filled tubes can be constructed from lightweight and fire-resistant material (e.g., aluminum (Al) material). The properties of Al make it an ideal choice, as it not only ensures the protection system durability but also prevents or inhibits the emission of smoke and sparks upon impact. FIG. 30a shows a battery cell positioned inside a tube that is filled with PCM; FIG. 30b shows a cross-sectional view taken along dashed line A-A′ in FIG. 30a; and FIG. 31 shows a battery pack with an array of battery cells each positioned inside a respective tube. Referring to FIGS. 30a, 30b, and 31, the tubes can be strategically positioned around the battery cells (e.g., EV battery cells), respectively, to provide comprehensive protection. That is, each battery cell can be positioned inside a tube that is filled with PCM. As used herein, PCM-filled tube or a tube that is filled with PCM means that PCM is disposed within the outer shell of the tube, which is partially or completely filled along an axis of the outer shell of the tube, but which has space for the battery cell in a radial direction, as seen in FIG. 30a). Though Al is discussed herein as a material for the tubes, embodiments are not limited thereto.

Each tube can have a thickness in a range of, for example, 0.5 millimeter (mm) to 20 mm (or any subrange or value contained therein, such as a preferred range of 1.5 mm to 4 mm). Each tube can have a diameter in a range of, for example, 20 millimeter (mm) to 100 mm (or any subrange or value contained therein, such as a preferred range of 45 mm to 60 mm). Each tube can have a first cap on a first end thereof and/or a second cap on a second end thereof opposite from the first end. The first cap can have at least one orifice (e.g., at least four orifices or, preferably, exactly four orifices), and the second cap can have at least one orifice (e.g., at least four orifice or, preferably, exactly four orifices). The first and second caps can each be made of any suitable material, such as the same material as the respective tube (e.g., a metal such as aluminum). Each orifice can have a size (e.g., diameter or largest thickness) in a range of, for example, 0.5 millimeter (mm) to 10 mm (or any subrange or value contained therein, such as a preferred range of 2 mm to 6 mm). The orifices on each cap can all be the same as each other or can all be different from each other, or some combination thereof. The orifices of the first cap can be the same, different, or a combination thereof as the orifices of the second cap. The inclusion of one or more caps with at least one orifice can allow PCM to squeeze out during a collision event, thereby advantageously improving collision protection.

The PCM material used inside the tubes plays a dual role in enhancing the safety of the battery pack. First, during a collision, the PCM material squeezes out through one or more orifices, efficiently absorbing and dissipating a significant amount of energy. This process effectively reduces impact forces and protects the batteries from physical damage. Second, in the event of a fire, when the composite PCM is combined with halogenated flame retardants (FRs) such as bromine, chlorine, or fluorine, they act as flame quenchers by interrupting the combustion process. They react with the free radicals that are produced during the combustion process, thereby preventing or inhibiting the fire from spreading and minimizing its impact. The inclusion of halogenated FRs further enhances the safety of the battery protection system, ensuring that even in instances of fire, the spread of flames is suppressed, reducing potential damage (e.g., to the EV and its occupants in the case of an EV battery). The combination of the composite PCM material for energy absorption and the incorporation of halogenated FRs for fire prevention/inhibition makes the battery protection systems and methods a comprehensive and robust safety solution for batteries, such as batteries for EVs (instilling confidence in EV users and manufacturers in the case of EV batteries).

Under crash conditions for an EV battery, the PCM-filled tube(s) can act as (an) energy absorber(s), efficiently dissipating impact energy and minimizing the risk of battery damage during collisions. The presence of the squeezable PCM material inside the tube(s), combined with the orifice effect, enhances energy absorption capabilities without requiring phase change. This is a unique approach to enhancing energy absorption, distinct from traditional energy absorber systems. While traditional systems rely on separate mechanisms for heat dissipation and impact absorption, the PCM-filled tubes of embodiments of the subject invention combine these functionalities into a single, innovative unit.

Furthermore, the novelty lies in the unique combination of the squeezable PCM material and the utilization of the orifice effect to enhance energy absorption. The PCM plays a key role in increasing pressure inside the tubes when subjected to external forces. This increased pressure, combined with the orifice effect, allows the tubes to efficiently absorb and dissipate a substantial amount of energy during impacts, making it an innovative approach to enhancing energy absorption in tubes.

Additionally, the exceptional thermal properties of the PCM provide an added advantage by aiding in temperature regulation. The PCM material effectively manages battery temperature rise during harsh electric pressure, thermal events, and extreme temperature fluctuations. This thermal regulation helps maintain the battery temperature within a safe range, thereby enhancing battery performance, extending its life, and reducing the risk of thermal runaway.

In some embodiments, the PCM can include an additive, such as graphite (e.g., expanded graphite (EG)). For example, a mixture of paraffin wax (PW) and graphite (e.g., EG) can be included in the tubes. Such an additive can help overcome the inherent limitations of batteries (e.g., LIBs) in heat dispersion, particularly at extreme discharge rates. The weight ratio of additive to bulk PCM can be in a range of, for example, 1:5 to 1:25, such as 1:15 or about 1:15. In one embodiment, graphite (e.g., EG) can be added to a PCM (e.g., PW) with a weight ratio of 1:15 (or about 1:15; i.e., graphite with a mass percent of 6.25% or about 6.25%).

Embodiments of the subject invention can combine heat dissipation and energy absorption systems into a single unit, effectively enhancing the overall safety, reliability, and performance of batteries (e.g., EV batteries, such as lithium ion EV batteries) in a wide range of operating conditions. The multifunctional capabilities can help make a significant impact on advancing the safety and sustainability of EVs, thereby promoting the broader adoption of clean and eco-friendly transportation solutions.

Embodiments of the subject invention provide several key advantages over existing battery protection devices and methods. First, the squeezable PCM provides an additional means of absorbing energy, complementing the structural integrity of the tubes. Second, the orifice effect, combined with the increased pressure from the squeezable material, leads to improved energy absorption efficiency during impacts. Third, the lightweight and fire-resistant material (e.g., Al or Al-based material) used for the tubes ensures minimal weight addition to the overall battery system, making it a promising solution for EVs. This leads to improved battery safety and reliability, reducing the risk of battery damage and enhancing the overall performance of the device having the battery (e.g., an EV).

Embodiments of the subject invention are useful in, for example, EVs. As more consumers and businesses shift towards electric mobility, there is an increasing demand for advanced battery protection systems that can ensure the safety and reliability of EV batteries. The multifunctional battery protection systems and methods can be integrated into various EV models, offering a solution to enhance battery performance and safety. Manufacturers of EVs can leverage this system/method to provide customers with a distinct competitive advantage, promoting the adoption of their EV models. Beyond the EV industry, the multifunctional battery protection systems and methods can also find applications in other energy storage systems that require reliable heat dissipation and impact absorption capabilities. As the world moves towards sustainable energy solutions, embodiments of the subject invention can play a crucial role in various sectors where energy storage is a critical component. Embodiments address fundamental safety and performance aspects of EVs and other fields, aligning with the global push for sustainable and safe transportation solutions. As the EV market continues to expand, the multifunctional battery protection systems and methods of embodiments of the subject invention can be vital for enhancing the safety and reliability of EVs worldwide.

Crash absorbers that are well-designed and dependable should be lightweight but capable of absorbing a significant amount of energy in the event of an accident. In many structural applications, thin-walled metal tubes can be used as impact energy absorption devices because they are capable of dissipating kinetic energy via plastic deformation in different collapse modes including lateral/axial crushing and tube inversion or splitting, hence enhancing the structure's crashworthiness.

Rigid, perfectly plastic, and simplified deformation patterns have been used for a circular thin wall tube's progressive crushing ([1]). These can include two limbs connected by a plastic hinge, which can be formed by a combination of inside and outside folding with their entire length being susceptible to crushing during deformation (see also [2], [3]). The axial crushing modes and energy absorption properties of quasi-statically compressed aluminum alloy tubes have been considered ([4]). Circular tubes provide better crushing performance because a circular tube absorbs double the energy compared to square tube ([5]). Tubular constructions are prone to oblique or lateral (transverse) collisions in automobile application. Aluminum tubes, owing to their ductile character, exhibit superior crashworthiness compared to brittle composite tubes; and a thicker aluminum tube, in particular, offers significant advantages over composite tubes ([6]). Additionally, aluminum tubes outperform plastic tubes in terms of overall crashworthiness and cost efficiency. When the tube's thickness increases, its lateral crushing behavior improves, and its cost efficiency increases. Also, tubes of lower diameter to thickness ratio (D/T) values have greater energy absorption capacity compared to tubes of higher D/T values ([7]). Among specimens of the same thickness but varied diameters, specimens with smaller diameters have a greater energy absorption capacity and mean collapse load. Cellular material filler, such as metal foam or honeycomb can be used to reinforce a column ([8]), and foam filler can increase lateral load and energy absorption capacity during compression tests ([9]), with the length of the tube having a direct relation with the compression force and the amount of energy absorbed. Metal foam filling can improve lateral loading and energy absorption capacity of foam-filled tubes, which rise as the density of the foam increase ([10]).

The temperature management of batteries is important, and two main battery thermal management methods can be used. A battery pack can be cooled actively utilizing either wind or liquid as a refrigerant, or passively using PCM. One of the main deficiencies of the air-cooling method is low efficiency ([11]). Meanwhile, liquid-based approaches require extra equipment such as pumps and pipes, which is against the lightweight design of EVs. PCM cooling offers several benefits over the active technique, including cheap cost, homogeneous temperature, and no extra power requirements. When the PCM phase changes over a very limited temperature range, the latent heat stored in it helps limit or minimize battery temperature rise.

PCMs are classified according to their phase change mechanism into the following categories: solid-solid; solid-liquid; solid-gas; and liquid-gas. One benefit of solid-solid PCMs over other types is their low volume change during phase transitions. Additionally, solid-solid PCMs are leak-proof, need no encapsulation, and have less segregation. On the other hand, solid-liquid PCMs require container maintenance, which adds to the expense (see also [12]). The liquid phase of such PCMs has a lower heat conductivity than the solid phase. A unique feature of solid-solid PCMs is that their conductivity rises at high temperatures ([13]). PCMs can provide a more even temperature distribution inside a battery module ([14]; see also and [16]).

Embodiments of the subject invention provide systems and methods for enhancing energy absorption through the orifice effect using PCM-filled tubular thin-walled structures. An incompressible, high heat capacity substance can be used to fill the energy absorbers (i.e., tubes), which allows not only for improved energy absorption but also enhanced heat energy dissipation for multi-purpose applications. Embodiments are useful for many industries, including but not limited to transportation and infrastructure.

Embodiments of the subject invention provide systems and methods of energy absorption via PCM-filled tubes (e.g., cylindrical tubes with circular cross-sections) with caps and orifices on their end surfaces. Energy absorbers (i.e., energy-absorbing tubes) can be filled with a squeezable material, and the filled tubes can offer superior energy absorption performance compared to hollow tube systems due to energy dissipation during material squeezing through orifices. Experiments show how these tubes react when crushed by quasi-static lateral force, such as using a hemi-cylindrical indenter to laterally compress the samples (see the examples). Using systematic case design (SCD) and finite element (FE) methods, information on the effect of geometrical parameters of filled tubes was collected, such that guidelines could be determined for use as energy absorbers under lateral compression.

Embodiments of the subject invention enhance the safety, reliability, and performance of EV batteries in multiple ways. First, the PCM-filled tubes act as efficient heat sinks, effectively dissipating excess heat generated during harsh electric pressure or scenarios that may cause temperature rise. This prevents or inhibits the batteries from overheating and reduces the risk of thermal runaway, thereby extending the operational life of the batteries. Second, during collisions or impacts, the PCM inside the tubes plays a crucial role as an energy absorber. The PCM squeezing out through one or more orifices enhances energy absorption and dissipates significant amounts of energy upon impact. As a result, the PCM-filled tubes minimize the forces transmitted to the batteries, reducing the risk of battery damage and increasing the safety of EV occupants.

Embodiments of the subject invention can be used by, for example, EV manufacturers, battery pack manufacturers, automotive safety equipment suppliers, energy storage system manufacturers, and/or consumer electronics manufacturers. As the automotive industry continues to transition towards sustainable and electric transportation solutions, the demand for advanced battery protection technologies to enhance safety and reliability increases. EV manufacturers in particular can utilize the advantages provided by embodiments of the subject invention by incorporating the battery protection into EVs to ensure the safety of their battery packs during collisions and impacts.

Farzaneh et al. (Enhancing electric vehicle battery safety and performance: Aluminum tubes filled with PCM, Journal of Energy Storage 97, 112922, 2024) describes certain features and examples of embodiments of the subject invention and is hereby incorporated by reference herein in its entirety.

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Materials and Methods

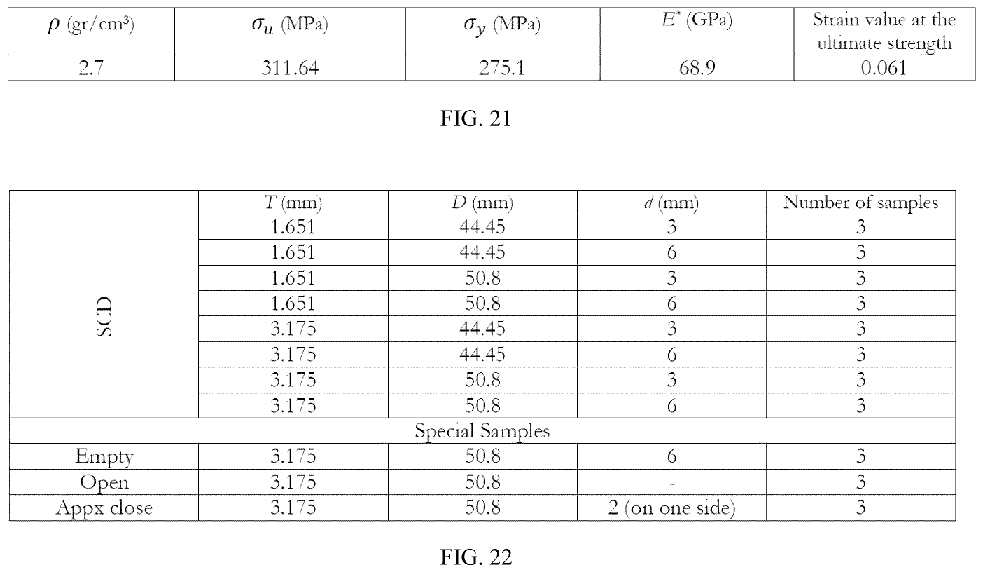

Aluminum 6061-T6 (Al 6061 T6) is frequently used in avian and marine products as well as in the vehicle industry because, compared to other aluminum alloys, it is better in corrosion resistance, high coatability, strength, formability, ease of weldability, availability, and affordability ([17]). Al 6061 T6 tubes were used in the examples. The tubes were cold drawn and manufactured according to the ASTM standards (ASTM B210). Based on the manufacturer inspection certification, mechanical properties of Al 6061 T6 are shown in the table in FIG. 21 and used in the finite element (FE) modeling.

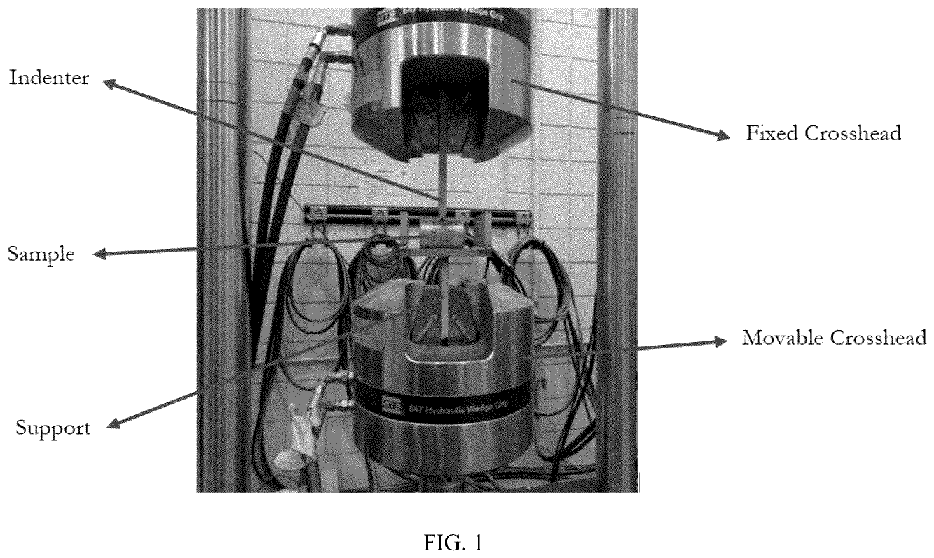

The examined substances were subjected to quasi-static testing using MTS® systems 810 testing equipment (model number: 318.10) (see also FIGS. 3a-3d). A load cell was mounted to the movable crosshead of the loading frame to determine the loading force. The crosshead movement and acquisition system from the loading frame were both controlled by the software that came with the MTS machine. A hemi-cylindrical indenter with a radius of 4.7625 mm, a width of 76.2 mm, and a length of 177.8 mm was fixed by the upper wedge grip and the support was fixed by the lower wedge grip. In order to eliminate any potential dynamic effects, the instrument crosshead was moved at a predetermined slow velocity of 5 mm/minute (displacement control) (see also [18], [19]). FIG. 1 shows an image of the test setup used to test the samples.

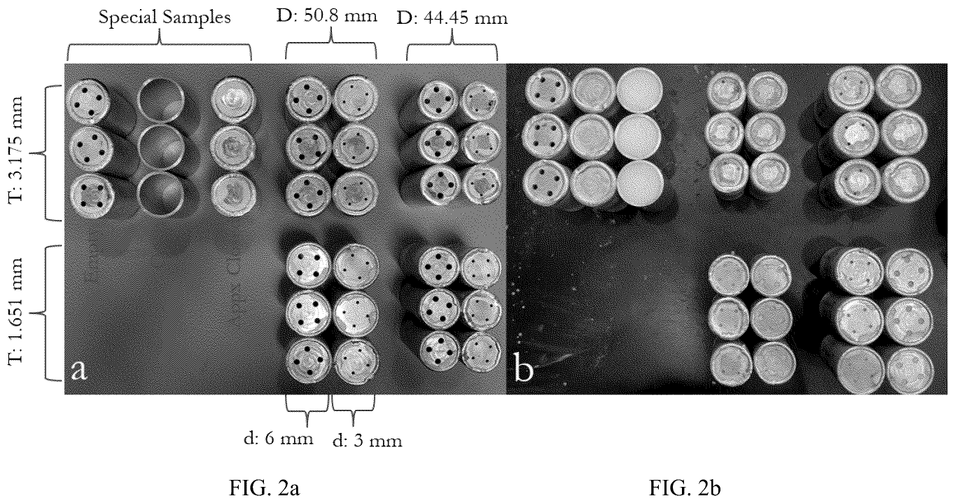

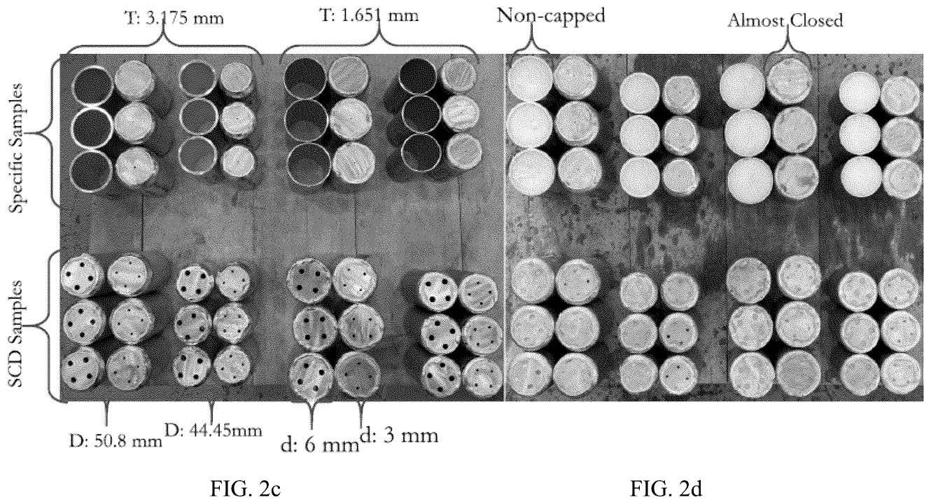

Considering energy absorption for the purpose of EV battery cells, the length of all specimens was assumed to be 65 mm, which is the same length as the Panasonic 18650 battery cell used in EVs ([20]). Moreover, variations in geometrical characteristics are listed in the table in FIG. 22 and are also shown in FIGS. 2a and 2b, depending on the availability of Al 6061 T6 tubes. There must be 2³=8 permutations for the specimens, according to SCD, as there were two variants for the three geometrical parameters. Moreover, specific samples (open, almost closed (with a 2 mm orifice on one side for possibility of PCM filling), and empty (all with a thickness (T) of 3.175 mm, a diameter (D) of 50.8 mm, and an orifice size (d) of 6 mm)) were considered for presenting the extreme values for energy characteristics. In order to decrease the experimental error, for each combination of parameters three identical samples were prepared and average results were reported.

### Example 1

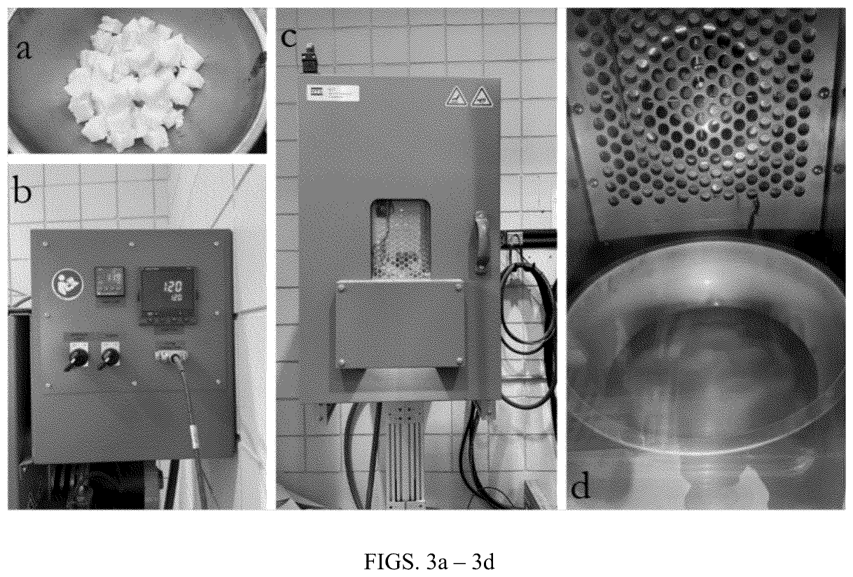

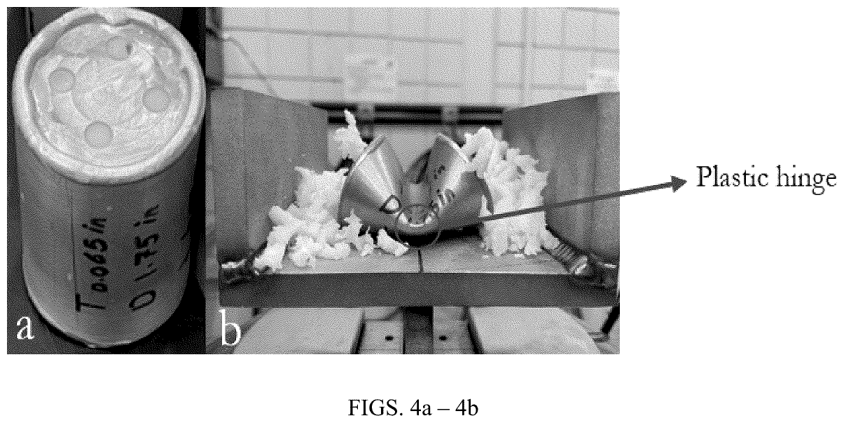

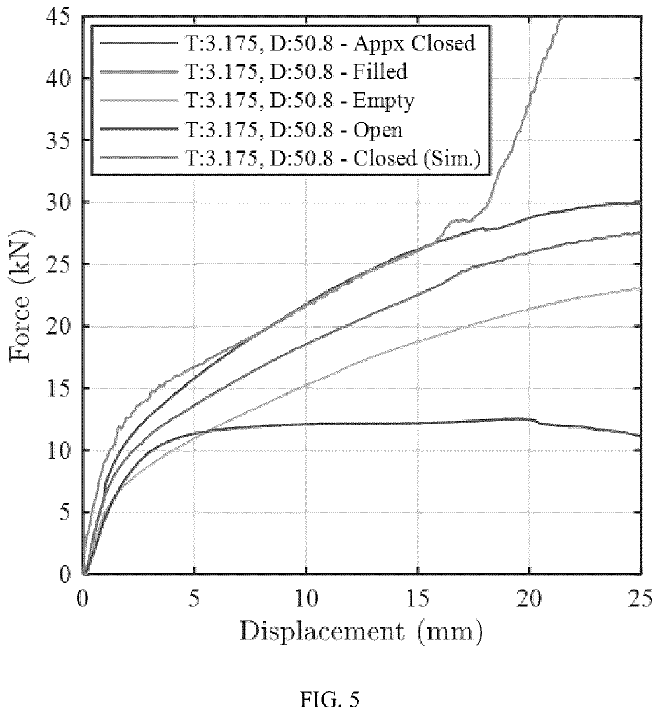

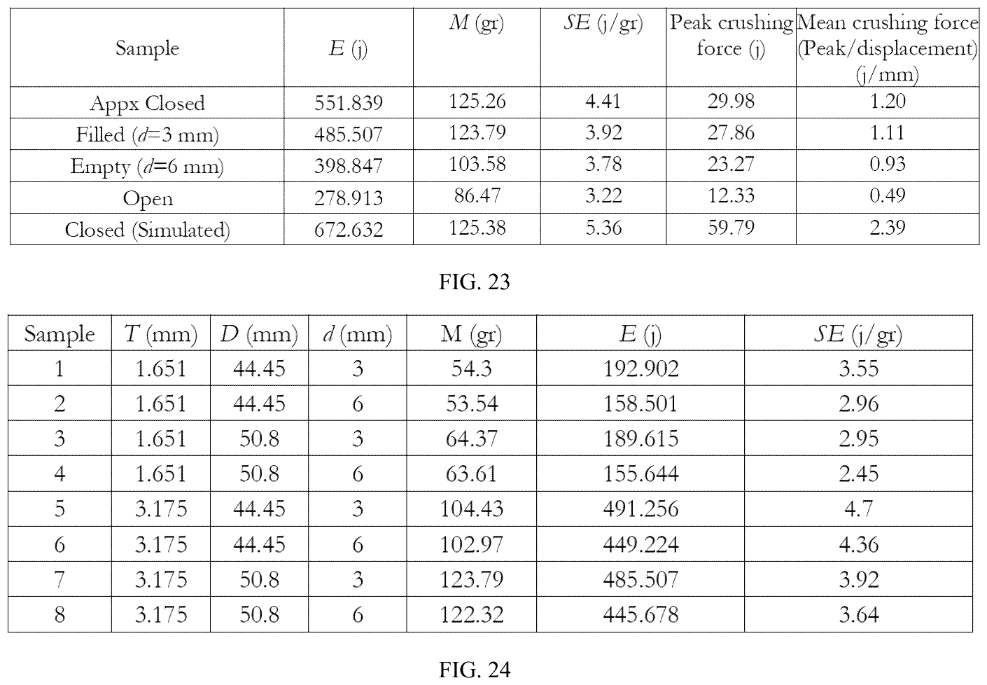

In order to exemplify the superior crash resistance of PCM-filled and capped end tubes, the crush behavior of special samples versus PCM-filled tubes were compared. FIGS. 4a and 4b show a PCM-filled sample before and after, respectively, indentation. FIG. 5 shows a plot of the force-deflection responses of empty and filled tubes under quasi-static loading, while the table in FIG. 23 compares corresponding absorbed energies.

The onset of buckling, represented by the collapse of the tube, can be seen in force-displacement curves as a shift in the stability of the structure (at the corner of each curve). The initiation of buckling occurred with lower deflection in capped end tubes because the location of curve corner was on the left side of open-end tube as shown in FIG. 5. Comparing the quasi-static results of uncapped and capped cylindrical tubes demonstrated that the use of cap in the cylindrical tube enhances the absorbed energy considerably. This means that formation of non-reversible (plastic) hinges in the capped tubes needed more force than open tube with the same deflection, which has resulted in higher energy absorption (example: empty and filled samples as capped samples showed 43% and 74.07%, respectively, increase in energy absorption with respect to the open sample as non-capped sample).

The impact of squeezable material inside the energy absorber was evidenced by the difference in energy absorption between the empty and filled tubes with identical geometrical characteristics (T=3.175 mm, D=50.8 mm). This led to a 21.73% increase in energy absorption. Further, filling the structure with PCM material and utilizing the orifice effect resulted in an increase of 86.66 Joules (J) in energy absorption, equivalent to 17.8% of the total absorbed energy in the filled structure. This increase was attributed to the PCM material squeezing out of the structure through the orifices. While aluminum foam can be used to enhance energy absorption capabilities of structures under quasi-static loading conditions, PCM-filled tubes are advantageous in enhancing energy absorption (see also [21]).

In addition, the influence of orifice size is shown by the 13.66% increase in energy absorption between the approximate closed (Appx Closed) and filled tubes with the same geometrical parameters except the orifice that there was only one 2 mm orifice on one side of the Appx Closed sample compared to four orifices with the size of 3 mm on both sides of the filled sample. However, other energy absorption indicators such as peak crushing force (maximum of force history during crushing) and mean crushing force (peak force/displacement) of the Appx Closed sample were higher than those of the filled sample, which means that higher force would be transferred with such a configuration instead of dissipating energy. The lower values for these two indicators show better performance of the structure in terms of crushing load transfer. Thus, incorporating orifices to allow material to escape reduces energy absorption compared to the Appx Closed sample. However, it increases the energy absorption capacity compared to the empty sample. Therefore, out of the three samples, the filled sample performed the best in terms of dissipating energy and minimizing crushing force transfer. Also, a change in the energy absorption proved the controllability of the energy dissipation through the orifice effect. The peak crushing force and mean crushing force of the closed (simulated) sample were both much higher than that of the other samples, lending credence to the claim that less area for material squeeze would result in higher force transfer.

### Example 2

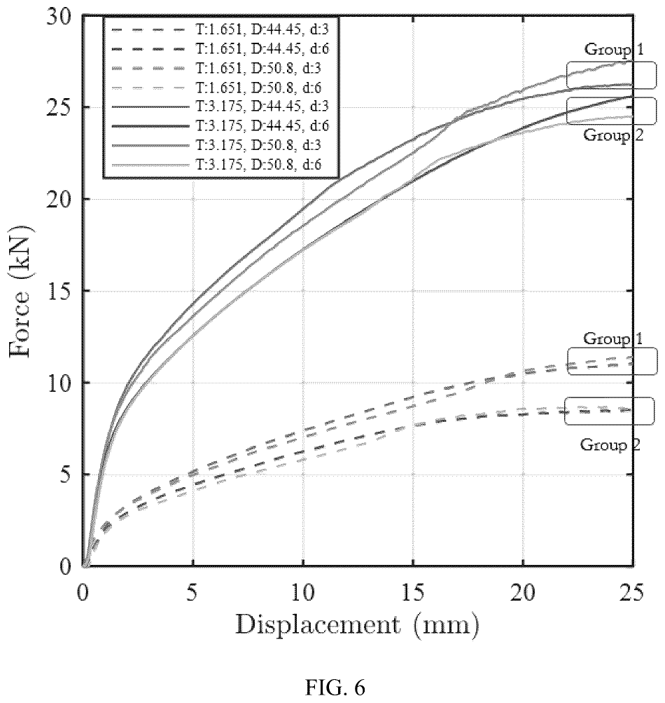

FIG. 6 shows the force-displacement results of a quasi-static indentation test conducted on PCM-filled samples in accordance with SCD considering variation in parameters for the eight possible combinations of characteristics. The corresponding absorbed energies for these samples are shown in the table in FIG. 24Error! Reference source not found.

A comparison of the dashed and solid lines of the same color in FIG. 6 illustrates the effect of an increase in thickness on the force needed for indentation. The influence of orifice size on energy absorption is also shown by two groups of two lines for each thickness group. For example, the difference in energy absorption between samples 1 and 2 or 3 and 4 (where only orifice sizes (d) change) in FIG. 24 demonstrates this claim. Also, by comparing samples with identical properties other than diameter, it can be seen that increasing the diameter decreased energy absorption slightly, but it was highly influential in terms of specific energy (SE) due to mass increase.

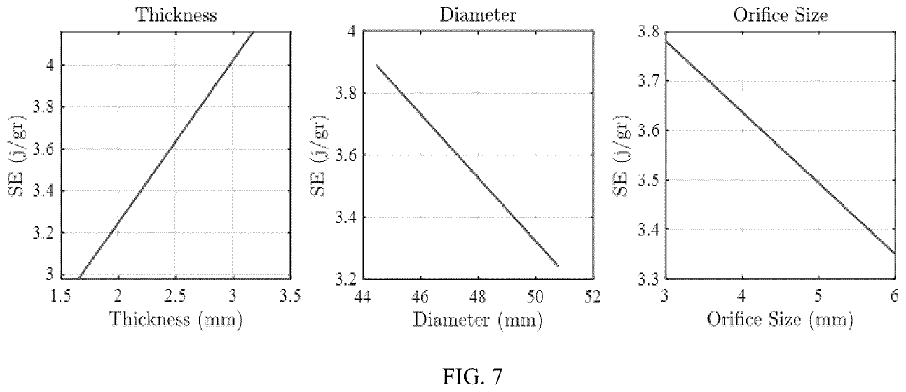

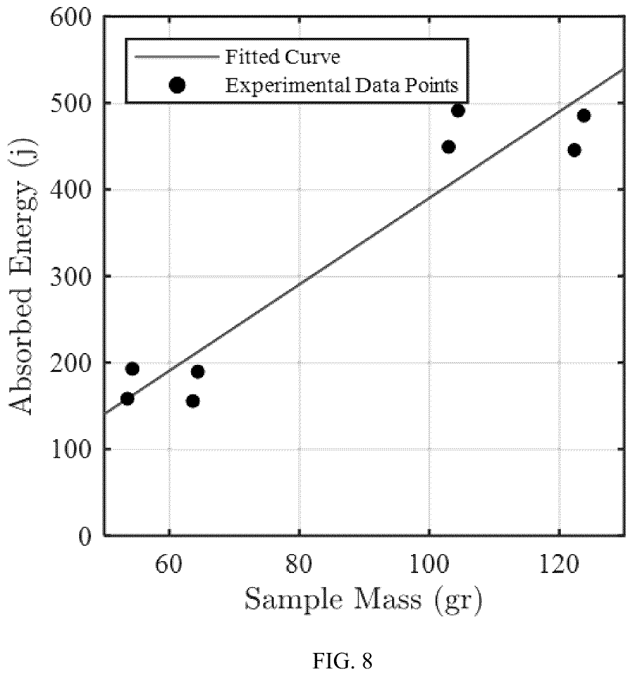

In order to reflect the influence of geometrical factors on SE absorption, the average of SE absorption versus the variable (T, D, and d) is plotted in FIG. 7. An increase in thickness (92.31% from 1.651 mm to 3.175 mm) and a reduction in orifice size (100% from 3 mm to 6 mm) led to an increase in the SE absorption of 39.7% and 11.31%, respectively, but a slight increase in diameter (14.29% from 44.45 mm to 50.8 mm) resulted in a significant drop in SE (16.83%) owing to an increase in the sample mass. As shown in FIG. 8, the energy absorber mass has a major impact in the variance of absorbed energy. The slope of a first-degree polynomial fit is close to five, highlighting the influence of mass on energy absorption capacity.

### Example 3

Several metrics may be used to assess the efficacy of energy absorbers, such as energy absorption capacity, specific absorbed energy, and weight effectiveness (see also [22]). A key feature of energy absorbers is their SE. This is calculated using energy absorbed per mass, or

$$SE = \frac{E}{M} \qquad ( 1 )$$

where M refers to the mass of the energy absorber. The area beneath the force-displacement response of an energy absorber gives us energy-absorbing capacity, or E. This energy is defined as the following equation.

$$E = {\int }_{0}^{δ} P ( δ ) . d δ \qquad ( 2 )$$

where δ denotes displacement and P(δ) is the force-displacement relation.

Al 6061 T6 was modeled using the Johnson-Cook (JC) material model, the conventional material model for modeling aluminum alloy, as the material keyword in LS-Dyna software. Hardening law, rate, and temperature dependency are all represented analytically in the JC plasticity model. In equations, the model is expressed as shown in Equation 3 (see also Johnson, A constitutive model and data for materials subjected to large strains, high strain 505 rates, and high temperatures, Proc. 7th Inf. Sympo. Ballist., pp. 541-547, 1983; which is hereby incorporated by reference herein in its entirety).

$$σ = ( A + B {ε}^{n} ) ( 1 + C ln \frac{\dot{ε}}{\dot{{ε}_{0}}} ) ( 1 - {( \frac{{T}^{*} - {T}_{room}}{{T}_{melt} - {T}_{room}} )}^{m} ) \qquad ( 3 )$$

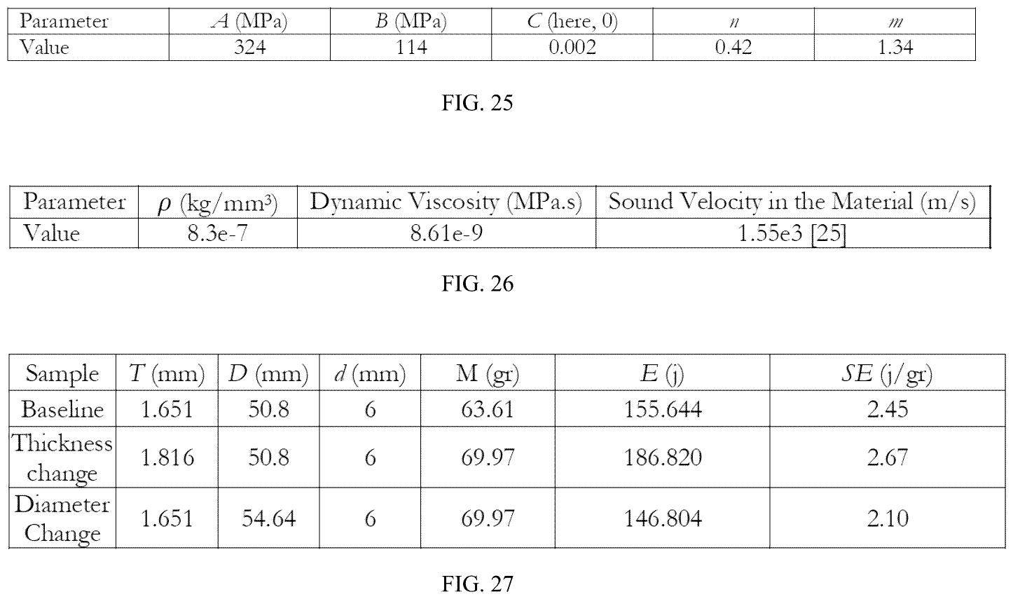

Stress versus strain is shown in the first pair of parentheses, while the influence of strain rate on yield strength is displayed in the second pair. However, because quasi-static load is applied on the samples in this examples the coefficient C is set to be zero. Temperature has a lowering influence on yield strength, as seen by the third set of parentheses. The table in FIG. 25 provides the values for the JC material model used in this example (see also Lesuer et al., Modeling large-strain, high-rate deformation in 507 metals, Lawrence Livermore National Lab. (LLNL), Livermore, CA (United States), 2001; which is hereby incorporated by reference herein in its entirety).

The PCM material was simulated using 009_NULL material model in LS-Dyna accompanied by Gruneisen equation of state (EOS) using parameters shown in the table in FIG. 26. Values for material density and dynamic viscosity were provided by the producer company.

Employing FE approaches, the deformation behavior of PCM-filled tubes was simulated. Error! Reference source not found. depicts the FE model that was used to simulate the mechanical response under quasi-static indentation. The capped tube was modeled using Lagrangian 4-node shell elements with high deflection and plasticity characteristics. In order to simulate the impact of the squeezable material on the indenter force, a high-performance Smoothed-Particle Hydrodynamics (SPH) modeling technique was used to represent the PCM. The indenter and the support were simulated using rigid shell elements. Surface-to-surface contact was used to capture reaction forces between the indenter and the tube as well as the tube and the support. Node-to-surface contact keyword was used between SPH nodes and tube shell elements in LS-Dyna software. Prescribed_Motion_Rigid boundary condition was used to define a displacement control movement with the velocity equal to the experiment for the indenter and the support was fully fixed.

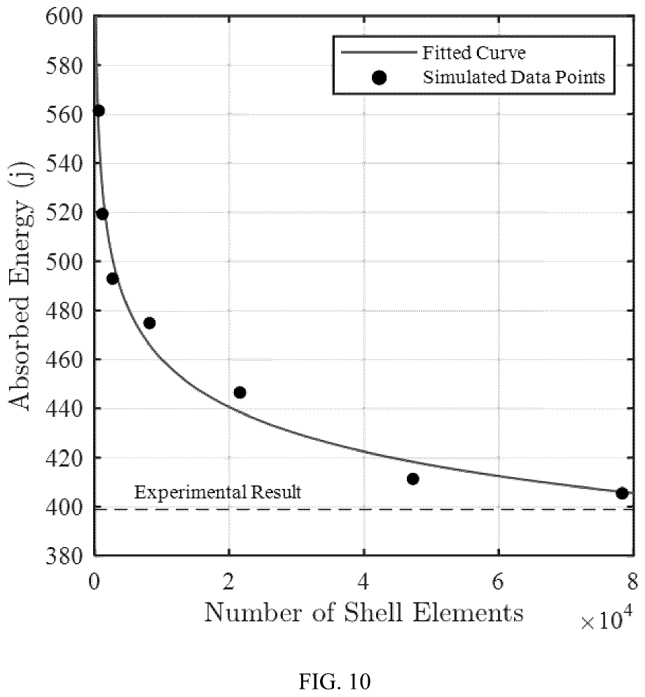

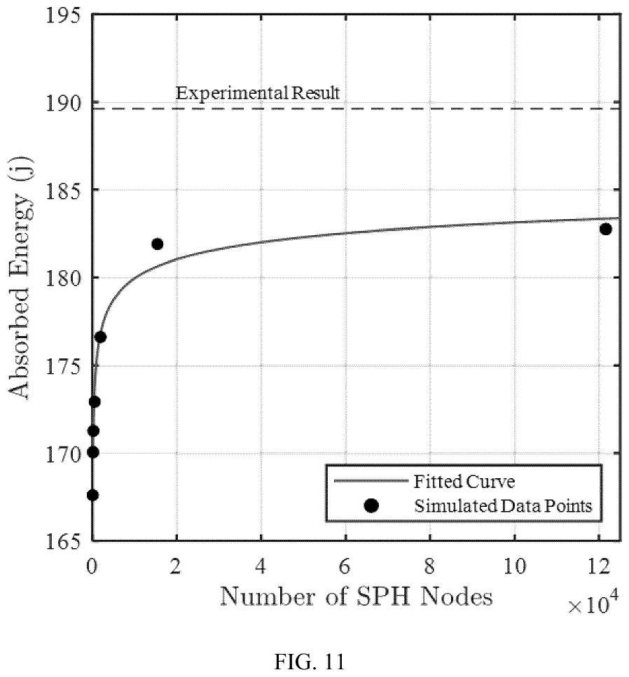

The complexity of soft material squeezing necessitated checking the acceptability of numerical studies by analyzing mesh convergence in Lagrangian and SPH media. FIGS. 10 and 11 illustrate the comparison between the experimental result and the impact of varying the number of shell elements and SPH seeds on the absorbed energy. The experimental result of the empty sample was used for convergence study in tube shell elements and a filled sample with T=1.651 mm, D=50.8 mm, and d=3 mm was used for SPH medium. Results showed that an average mesh size of 0.65 mm for the tube with 15392 SPH seeds (node spacing of 2 mm) would yield less than 5% error with respect to the corresponding experimental result.

### Example 4

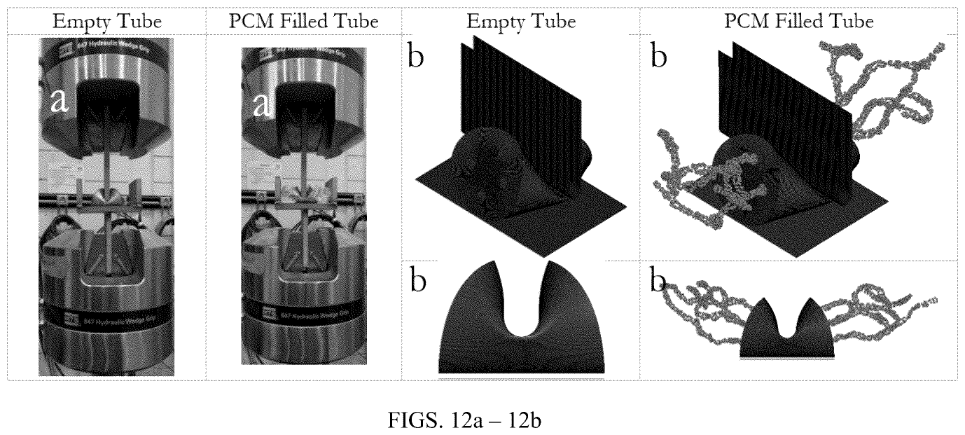

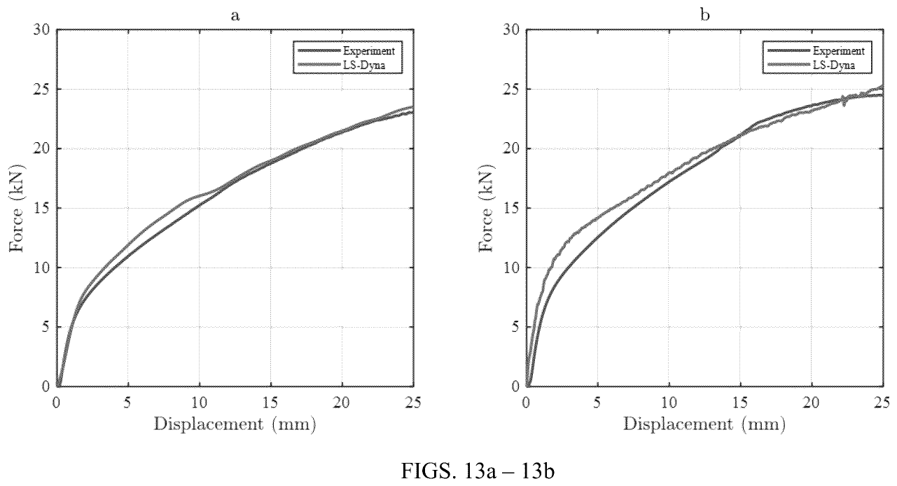

FIGS. 12a and 12b demonstrate the experimental and numerical, respectively, indented empty and filled tubes used to validate the numerical technique in comparison to the experimental testing. FIGS. 13a and 13b show the consistency between the FE simulation and the quasi-static experimental data for the deformation curves of capped cylindrical tubes subjected to a crushing force (both empty and filled tubes). The displacement at which buckling occurred in the simulated result compared to the experimental result indicated adequate simulation accuracy. The table in FIG. 29 summarizes the comparison between the experimental and numerical results for all of the tested samples. All quasi-static findings demonstrated a high degree of concordance (less than 5% difference) between numerical simulation and experiment data. This consensus demonstrated the validity of the FE model. I n the initial phases of deformation, however, FE simulation results deviated slightly. This divergence is attributable to definition of contact, friction coefficients and tangential slippage occurred at the top of the tube, which enhanced the contact zone of the tube during the indentation (see also [26]).

### Example 5

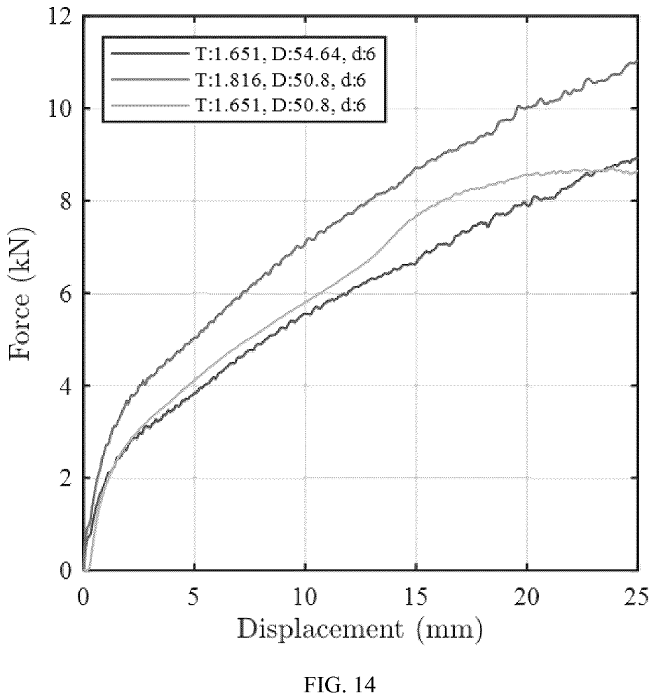

In order to show the effect of geometrical parameters with respect to sample mass, two samples were evaluated numerically with respect to a baseline model, with geometrical characteristics provided in the table in FIG. 27, such that the new masses were equivalent (69.97 grams), demonstrating the impact of thickness and diameter over the mass on energy absorption. FIG. 14 shows that, despite the fact that both samples gained mass equally, the SE enhanced by the thickness change while the SE reduced by the larger diameter sample with respect to the reference model. This demonstrates that the geometrical characteristics of an energy absorber have a greater impact on its ability to absorb energy than does the energy absorber mass.

### Example 6

An empirical formulation for predicting absorbed energy in accordance with geometrical parameter for PCM filled capped end aluminum 6061 T6 tubes was obtained as presented in Equation 6. In order to obtain the formulation the following steps were taken.

First, the positive/negative slope of the relationship between each parameter (thickness, diameter, and orifice size) and energy absorption were determined through systematic case design. This provided independent relationships for each parameter with respect to energy absorption as shown in FIG. 7, and they were placed in the numerator/denominator in the u formulation accordingly.

Second, ascending functions were applied to each of the parameters, as shown in Equation 5, to fit a curve based on the experimental data as well as validated finite element results with a high R-square value (close to 1).

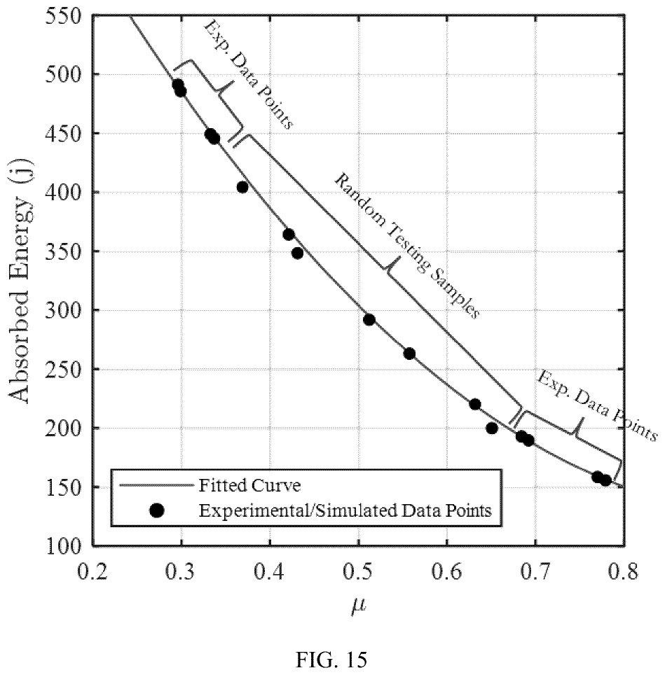

Third, MATLAB curve fitting tool was utilized to obtain the relationship of the fitted curve, which is displayed in Equation 6.

$$μ = \frac{{d}^{0.17} \times {D}^{0.09}}{{exp ( T )}^{0.55}} \qquad ( 5 )$$

$$E = 786.8 {μ}^{2} - 1535 μ + 874.6 \qquad ( 6 )$$

where μ is a parameter that includes geometrical variables (T, D, and d) together. It was assumed that absorbed energy and μ had a descending relation, so orifice size and diameter were placed in the numerator based on FIG. 7 results in terms of effect on energy absorption, while thickness was placed in the denominator. As seen in FIG. 15, the functions and powers in Equation 5 were selected such that a second-order polynomial curve could be fitted with great precision (R-square was 0.9998 using MATLAB curve fitting tool). FIG. 29 indicates the negligible error in predicted specific absorbed energies versus experimental results and less than 5% error in the results of random samples that were simulated to test the empirical formulation.

The random test sample in FIG. 15 represents the finite element result. A wide range of random samples were used and simulated based on validated mechanical properties in accordance with the experimental results. This approach confirms the accuracy of the empirical formulation and demonstrates its ability to predict energy absorption effectively when compared to experimental results and validated simulation.

### Example 7

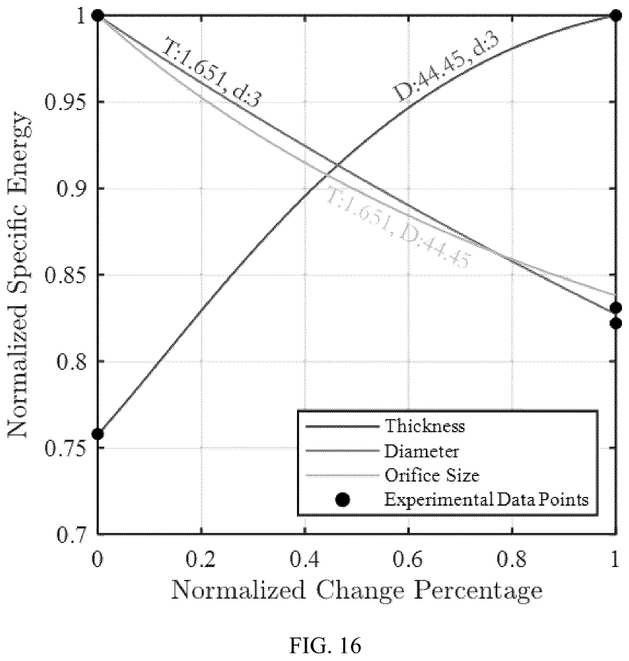

FIG. 16 displays how tube thickness (T), diameter (D), and orifice (d) affect SE by change in the range of experiment (0 and 1 on the x-axis represent 1.651 mm and 3.175 mm for thickness, 44.45 mm and 50.8 mm for dimeter, and 3 mm and 6 mm for orifice size). In order to be comparable, all the specific energies were normalized by dividing by the maximum for each curve. The interpolation of the experimental results was calculated based on Equation 6. A baseline sample for all data points considered was T=1.651 mm, D=44.45 mm, and d=3 mm. Thus, for example, all the data points on the thickness curve have the diameter and orifice size of 44.45 mm and 3 mm, respectively, while the thickness varies from 1.651 mm to 3.175 mm (with the same approach for the other two curves).

As tube diameter increased, the SE absorption decreased. Lower reaction forces were produced by using larger tubes since they provide less resistance to lateral collapse. This phenomenon occurred because the horizontal hinge points were farther away from the location of load application in larger tubes, so with the same force a higher moment would arise. A larger amount of force was needed to induce the collapse in the smaller tubes. This impact was found to be in agreement with the effect of tube diameter on collapse load for circular tubes (see also [7]).

As the thickness curve goes up, it becomes clear that thicker samples have a greater SE, while having a greater mass. This indicated that energy absorption increase dominated the mass gain that has resulted in an increase in SE absorption.

When the orifice size was reduced, the greater force necessary to squeeze the PCM out of the orifices enhanced energy absorption without considerably affecting the sample mass consequently resulted in improving SE.

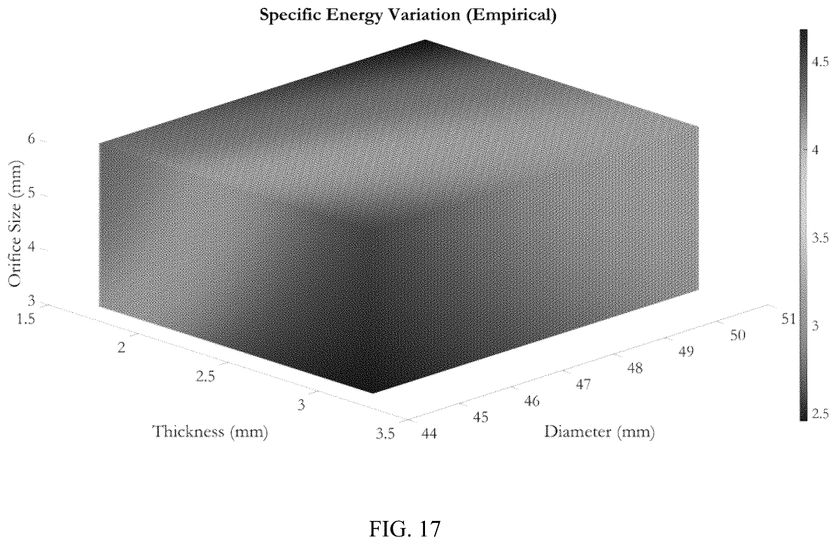

SE absorption varied with thickness, diameter, and orifice size, as illustrated in FIG. 17 Choosing the smallest possible diameter and orifice size while maintaining the highest possible thickness resulted in the highest SE.

### Example 8

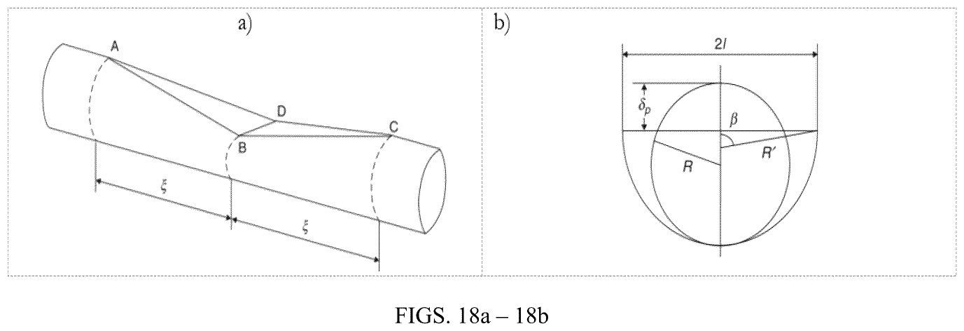

FIG. 18a depicts the distorted shape of a circular tube under indentation. Referring to FIG. 18a, plastic deformation is restricted to the region around the indenter, ABCD, and the area of the plastic zone expands with increasing deflection. It should be noted that indenter diameter has not been considered in the calculations and formulas (see also Lu and Yu, supra.). Consequently, the plastic hinges AB, AD, BC, and CD move during deformation, and the regions ABD and BCD are assumed flat. The cross-section of the tube at the location of indenter with respect to the initial shape is shown in FIG. 18b. The cross-section is supposed to be a circular arc whose straight endline coincides with the BD line.

The fully plastic bending moment at the cross-section is obtained by Equation 7 (see also Lu and Yu, supra.).

$${M}^{*} = \frac{{π}^{2} ( 2 sin α - sin β + sin β cos β )}{2 {( π - β + sin β )}^{2}} {M}_{t} \\ {M}_{t} = {YD}^{2} T \\ α = \frac{1}{2} ( π + β - sin β ) \qquad ( 7 )$$

where Y, D, and T are yield strength, tube diameter and thickness, respectively.

Force-displacement relation can be obtained from Equation 8 (see also Lu and Yu, supra.).

$$P = 4 {YT}^{2} {\{ \frac{π D δ}{3 T ( \frac{D}{2} - T )} [ 1 - \frac{1}{4} {( 1 - \frac{N}{{N}_{p}} )}^{3} ] \}}^{\frac{1}{2}} \qquad ( 8 )$$

where, N/Nₚ=0 and 1 for a tube with free ends and fully fixed ends, respectively. In this case, the end tube has been capped but with free ends (i.e., N/Nₚ=0) under indentation. Thus, an adjustment coefficient with respect to the experimental results is considered to have the force-displacement equation as described in Equation 9 when applying N/Nₚ=0:

$$P = 1.382 {YT}^{2} \sqrt{\frac{π D δ}{T ( \frac{D}{2} - T )}} \qquad ( 9 )$$

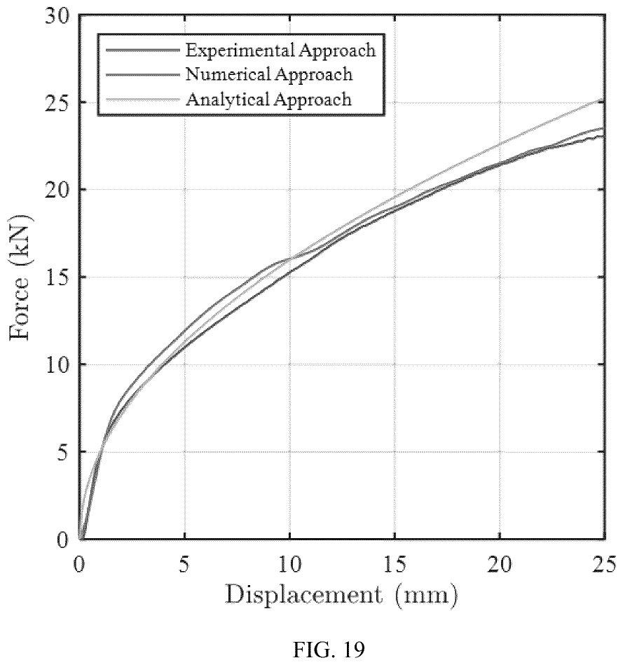

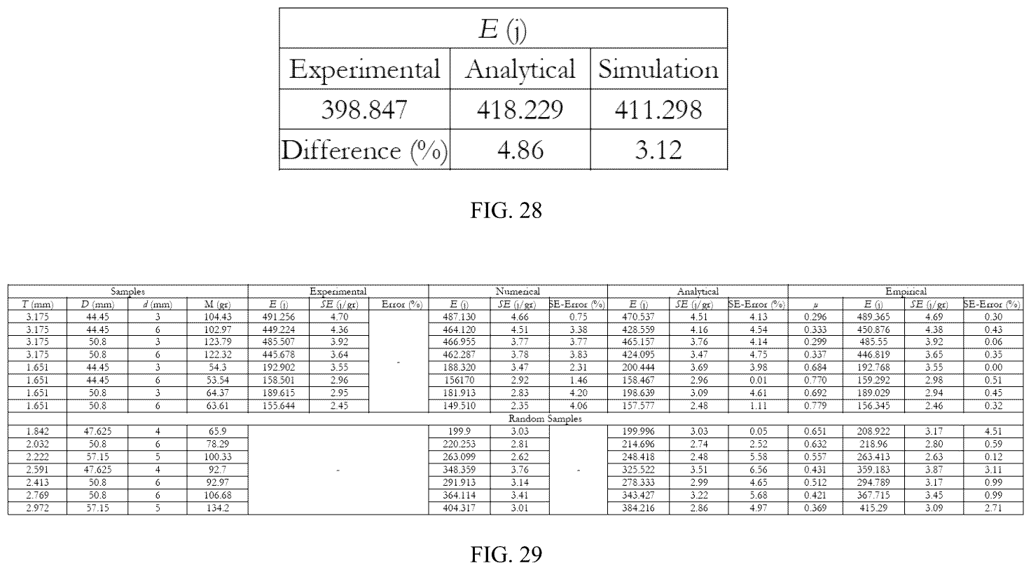

A visual representation of the correlation between the experimental, numerical, and analytical findings obtained with the use of Equation 9 is shown in FIG. 19 for the empty sample (T=3.175 mm, D=50.8 mm). There was a strong correlation between absorbed energies as compared in the table in FIG. 28 with respect to the experimental result.

Energy dissipation rate due to squeezing out a viscous material is analytically derived as shown in Equation 10 (see also Dugdale, Viscous flow through a sharp-edged orifice, Int. J. Eng. Sci., vol. 35, no. 8, pp. 515 725-729, 1997; which is hereby incorporated by reference herein in its entirety). In this study, the fluid was supposed to have a high dynamic viscosity, like Paraffin with λ=52.1 megapascal-seconds (MPa-s) at room temperature (25° C.) (see also [29]). An orifice of the diameter “a” is considered in Dugdale (supra.) while there are four orifices on each side of the capped tube; thus, in order to have a similar effective surface area, an equivalent diameter for the orifice size is considered, which is obtainable by Equation 11.

$$E = \frac{3 λ {Q}^{2}}{{a}^{3}} \qquad ( 10 )$$

$$a = 2 \sqrt{2} d \qquad ( 11 )$$

where Q is the volume flow rate and A is the dynamic viscosity of the fluid. Assuming a linear relation between force and tube deflection during the energy dissipation due to material squeeze, the force-displacement relation can be obtained by Equation 12.

$$P = \frac{3 λ {Q}^{2} Δ t}{8 \sqrt{2} {d}^{3} {δ}_{m}^{2}} δ \qquad ( 12 )$$

where Δt and δₘ are duration of material squeeze and maximum indentation, respectively. Using Equation 12 and superposing it with Equation 9, the force-displacement equation for a filled capped tube under indentation is obtained as Equation 13 shows.

$$P = 1.382 {YT}^{2} \sqrt{\frac{π D δ}{T ( \frac{D}{2} - T )}} + \frac{3 λ {Q}^{2} Δ t}{8 \sqrt{2} {d}^{3} {δ}_{m}^{2}} δ \qquad ( 13 )$$

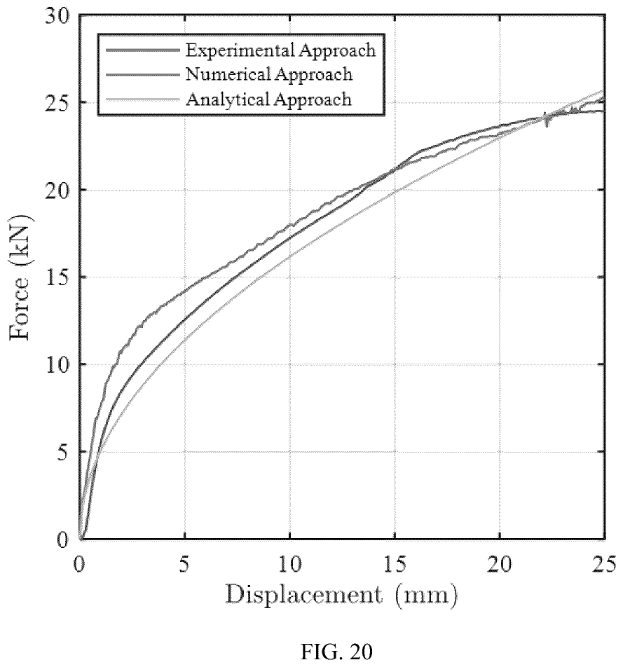

For a PCM-filled sample (T=3.175 mm, D=50.8 mm, d=6 mm), FIG. 20 provides a visual comparison of the agreement between experimental, numerical, and analytical results derived using Equation 13. The numerical and analytical approaches were highly correlated with the experimental outcome, as detailed in the table in FIG. 29.

Regarding the incongruities observed in FIG. 20 for the filled structure, it is important to note that the relatively larger difference (compared to the empty structure) is between the analytical and numerical methods. However, both approaches are reasonably close to the experimental results, with less than 5% difference. This observation can be seen in FIG. 29 quantitatively, which demonstrates that both the analytical and numerical methods have an acceptable deviation with respect to the experimental results. While there is a noticeable difference in the curve when the displacement is small for the filled structure, it is essential to emphasize that the overall results still maintain a reasonable degree of accuracy when compared to the experimental data.

With respect to the reliability of the relation that predicts energy absorption by integration of Equation 13, all experimentally tested samples are compared in FIG. 29 as well as random samples. As shown, there is less than 5% deviation from the experimental results in the analytical and empirical approach and less than 7% error with respect to the random samples that are simulated in LS-Dyna, which proves the reliability of empirical and analytical approaches.

Experimental investigations on the behavior of PCM-filled tubes were conducted in the examples. Filled tubes were crushed using a hemi-cylindrical indenter under quasi-static loading. Parametric studies were established based on SCD. FE analysis was validated by comparing numerically modeled samples with experimental results accordingly. The effect of geometrical parameters such as tube thickness, diameter, and orifice size on energy absorption capacity was analyzed. An empirical formulation was obtained based on interpolation of the experimental results and then verified with analytical approach.

The energy absorption capacity of tubes was enhanced through cap end and PCM filling by 43% and 74.1% in capped end tube and filled tube with respect to open tube, respectively. The effect of geometrical characteristics on SE absorption was shown. The maximum efficiency (highest SE) was obtained using the minimum size of tube diameter and orifice size and maximum thickness. The SE increased from 2.45 to 4.7 (i.e., 91.8% improvement) in experimentally tested samples. An empirical formulation for predicting energy absorption capacity of PCM-filled tubes under quasi-static indentation was derived with 95% accuracy. An analytical formulation of force-displacement subjected to hemi-cylindrical lateral indentation of empty and filled tubes were derived with 93% accuracy.

### Example 9

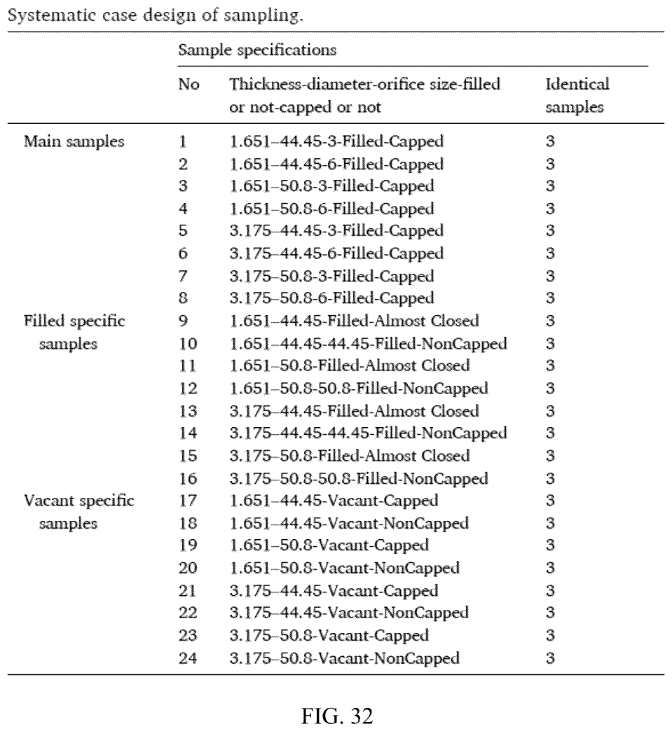

To serve as energy absorber for EV battery cells, specimens were standardized to a length of 65 mm, which aligns with the dimensions of the Panasonic 18,650 battery cell commonly employed in EVs. FIGS. 2c and 2d visually displays the variations in geometrical properties, and the table in FIG. 32 enumerates these variations. Considering the three varying geometric parameters, there are a total of 8 (2³=8) possible permutations for the specimens, as per the systematic case design (SCD) method. Further, specific samples were carefully chosen to represent extreme energy characteristics, including non-capped specimens, almost closed specimens (featuring a 2 mm orifice on a side to permit the inclusion of PCM), and vacant specimens. To ensure the reliability of the tests, three specimens were fabricated for each configuration. The reported results represent the average outcomes obtained from identical samples.

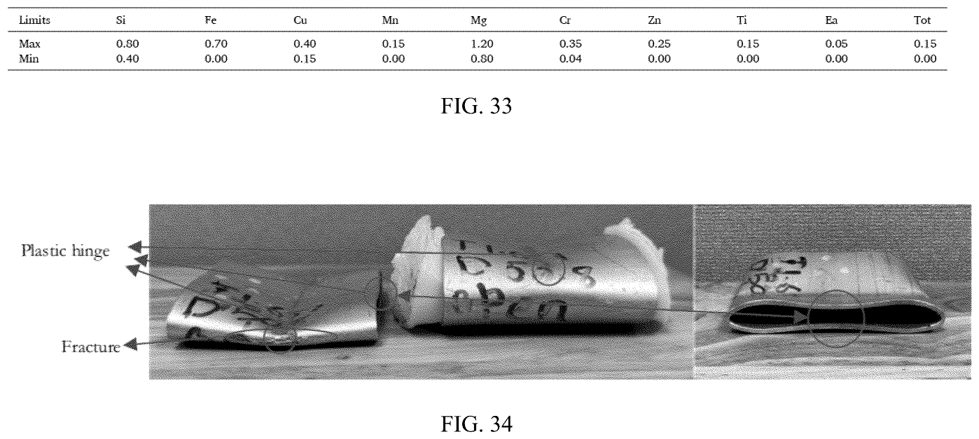

The choice of using aluminum 6061-T6 for this example stems from its widespread usage in aviation, marine, and automotive applications. Compared to other aluminum alloys, Al 6061 T6 offers superior protection against corrosion, excellent ability to apply a coating, notable durability, malleability, simplicity of weld-joining, accessibility, and cost-effectiveness. The tubes underwent a cold drawing process and were produced in compliance with ASTM B210 standard. The chemical makeup of this substance can be found in the table in FIG. 33. Mechanical properties, as confirmed by the manufacturer inspection certification, are also presented in the table in FIG. 21 and were adopted for the finite element modeling.

The liquefaction of RT54HC (the PCM), having a melting temperature at 54° C., was achieved using the MTS 651 environmental chamber. To ensure proper melting and allow sufficient time for sample filling before the PCM solidified, the environmental chamber was adjusted to a temperature of 150° C. Subsequently, the liquidized wax was injected into the tubes via designated orifices (see also FIG. 2d).

In the experiment, the specimens underwent transversal impact using an impactor featured a semi-circular head. To conduct the tests, a gravity-driven impact system equipped with magnetic lock for ensuring non-accelerated release was employed. This apparatus had a maximum capability for kinetic energy of 1500 Joules (J). The head of the impactor was made of stainless steel T316-Annealed in accordance with the ASTM A240 standard, featured a hemicylindrical shape having a 9.525 mm diameter and a 76.2 mm width. The impact occurred at the midpoint of the samples, and the impactor axis was perpendicular to the sample central axis. The samples were positioned on a rigid testing bed. A slight grooving at the bottom ensured that the samples were securely held at the middle of the bed.

Acceleration was measured using two accelerometers positioned on top of the impactor at the same time; the model number 352C03 with measurement range of 500 g's (acceleration gravity) for capturing high accelerations and 356A44 with measurement range of 100 g's for high resolution at lower acceleration range, from PCB Piezotronics, Inc. To record the data, the frequency rate for logging the data was set to 5 kilohertz (kHz) in NI-Max software. To improve data quality, we applied a 600 Hertz (Hz) band width filtration (BW). The noise filtration frequency was carefully chosen to minimize deviation from the original data, ensuring that the maximum acceleration difference between the raw and filtered data remained within 5%.

The test involved a 20.0 kilogram (kg) impactor, which accounted for the mass of the impactor along with the accelerometers and all connector components. The impactor was dropped from a height of 1073 mm (73 mm was added to compensate for the energy loss due to the friction caused by the sliding guides) onto the specimens. The velocity of the impactor was determined using the conventional equation for calculating the velocity of a falling mass subjected to gravity, V₀=(2gh)^{1/2}, where V₀ represents the speed at the moment of collision, h represents the original height from which the impactor was dropped, and g denotes gravity (9.81 meters per second squared (m/s²)). Given the distance was low enough, it was assumed that the influence of air drag could be neglected. To confirm the precision of the velocity, a velocity meter was employed at the impact zone. The velocity meter operated by measuring the time it took for the object to pass between two sensors. The results indicated a deviation of less than 2% between the observed and computed speeds, thus demonstrating the practicality of the equation for V₀ given earlier in this paragraph.

The samples were identified by their geometrical parameters. For instance, 3.175-50.8-6, indicated a thickness of 3.175 mm, tube diameter of 50.8 mm, and orifice size of 6 mm. Additionally, if a sample was vacant, noncapped, or almost closed, this was indicated at the end of its name, such as 3.175-50.8-non-capped or 3.175-50.8-almost closed.

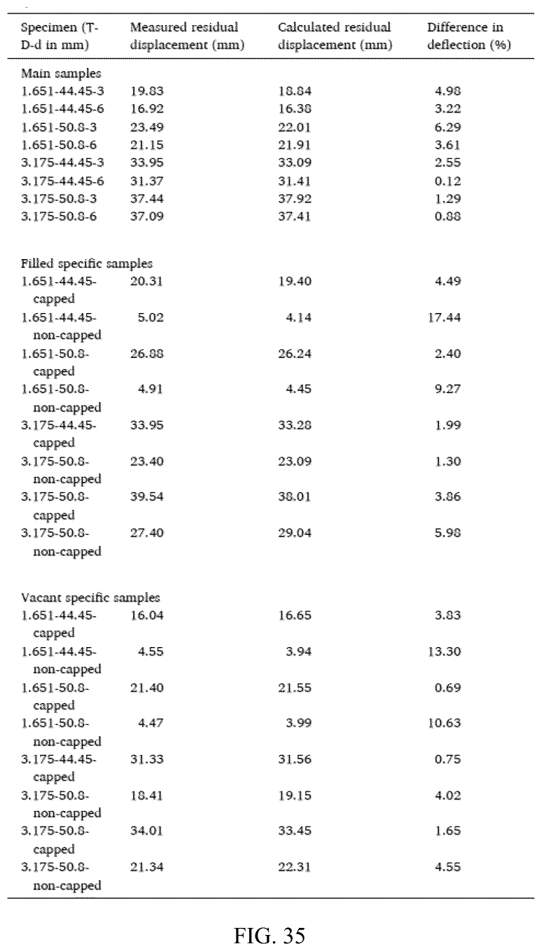

Upon completion of each experiment, the residual displacement at the line of impact was measured. A summary of the test results is presented in the table in FIG. 35, showing the deformation measured and calculated for each test. The calculated residual displacement was obtained by integration (Equation 15) and the measured residual displacements obtained by a calibrated digital caliper, which was affected by elastic behavior of the material.

The sensors recorded the acceleration of the impactor. The contact force experienced during the impact was determined by multiplying the mass of the impactor by its acceleration. FIG. 34 displays visual representations of the deflections observed in the specimens following the tests and the creation of plastic hinge in unfilled sample with respect to filled sample. The plastic hinges represent areas where the material has yielded to the point of plastic deformation, allowing the material to bend at those points without complete separation. PCM filling to the sample contributed to the less deformation patterns, increasing the rigidity and altering the distribution of stress across the sample. On the other hand, the unfilled sample, lacking reinforcement from filler, exhibited a more pronounced deformation and had a lower threshold for hinge formation and ultimate localized failure. The failure of the unfilled sample is characterized by a fracture, rendering the sample structurally ineffective.

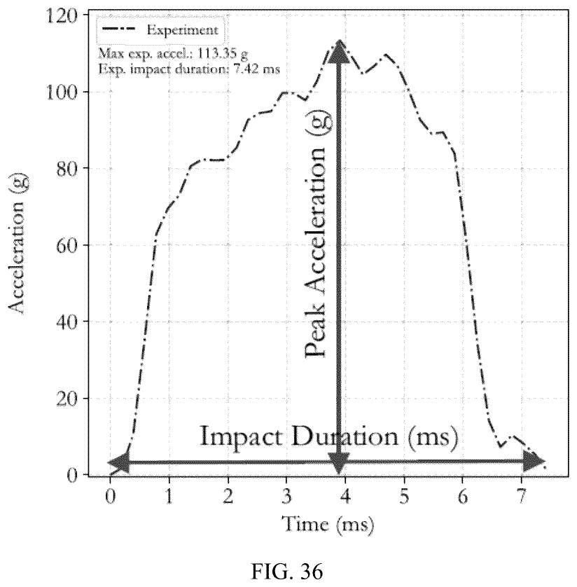

The time-dependent acceleration profile of the impactor is depicted in FIG. 36, showcasing a typical pattern. To calculate the duration of the impact, the period was measured between the points where acceleration direction changed.

The time histories of acceleration were integrated to get the velocity of impactor and its movement as they changed while the impact was taking place using Equations 14 and 15.

$$V ( t ) = {\int }_{0}^{t} a ( t ) dt + {V}_{0} \qquad ( 14 )$$

$$δ ( t ) = {\int }_{0}^{t} {\int }_{0}^{τ} a ( τ ) d τ dt + {V}_{0} t + {δ}_{0} \qquad ( 15 )$$

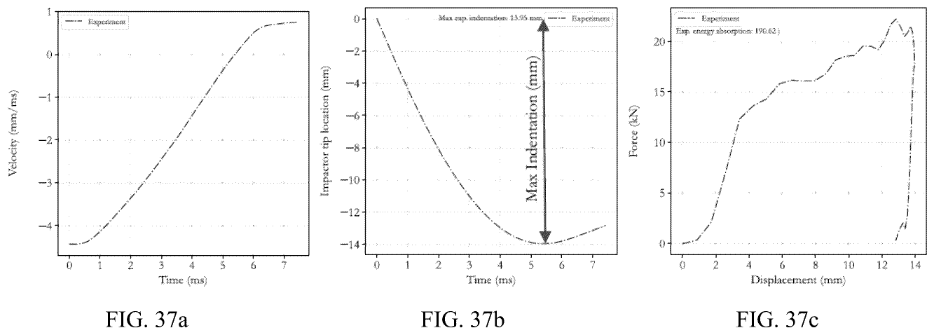

Time series of acceleration, velocity, and displacement were denoted here by the notation a(t), V(t), and δ(t), respectively. Using the equation above for V₀, the impactor initial velocity (V₀) at the onset of impact was calculated. It was assumed that 80, the initial displacement, was zero. The maximum deflection was calculated by analyzing the displacement time history. Application of Equations 14 and 15 for sample 3.175-44.45-6 are shown in FIGS. 37a-37c, along with force-displacement obtained from acceleration and displacement histories.

Various metrics can be employed to evaluate the effectiveness of energy absorbers. Using Equation 16, it was possible to compute the quantity of absorbed energy. Also, the results of calculated energies for all samples are noted in the table in FIG. 36.

$$E = {\int }_{0}^{δ} P ( δ ) d δ \qquad ( 16 )$$

The contact force between the impactor and the sample was represented by P(δ) as a function of impactor displacement (i.e. δ).

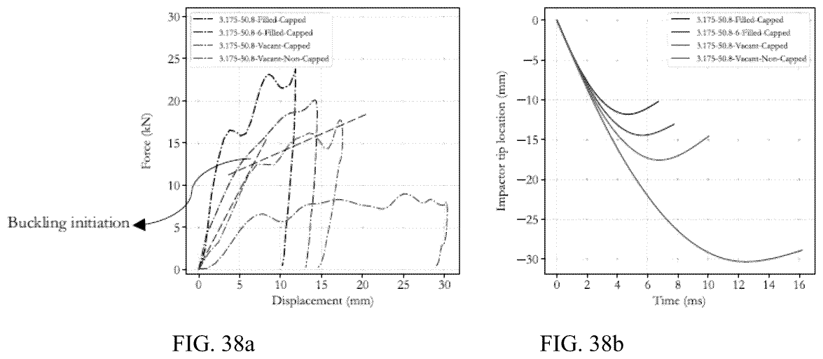

Regarding structural buckling, particularly observed in the context of tube collapse, where a noticeable change in the stability of the structure happens, this change was identifiable on force-displacement figures as a distinct alteration at each curve corner (annotated on FIG. 38a). Notably, tubes with capped ends began to buckle at a lower deflection compared to those with open ends. This difference was evident in the positioning of the curve corner, which appeared more to the left for tube with capped ends, as depicted in FIGS. 38a and 38b, which present the relationship between force and displacement for selected tube samples, all with identical thickness (3.175 mm) and diameter (50.8 mm), subjected to impact loading. This consistent geometry across the samples allowed for a focused comparison on the influence of other variables: the presence of end caps; the filling with PCM; and the existence of the orifices.

Starting with the 3.175-50.8-filled-capped tube, which was filled with PCM and had capped ends and no orifices, this configuration allowed for the highest force resistance, indicating that the PCM contributed significantly to the energy absorption capability with respect to vacant-capped counterpart. The maximum force reached was higher compared to the vacant-capped tube (33.8%), and the residual space left was 32.64 mm as the highest value among the selected samples. This suggested that the PCM, combined with a fully capped end, provided a cushioning effect that improved energy absorption as well as residual space.

The 3.175-50.8-6-filled-capped tube, with a 6 mm orifice and filled with PCM, showed a slightly different behavior. The presence of an orifice reduced the maximum force capacity to a level close to that of the 3.175-50.8-filled-capped tube, and the residual space was less at 30 mm, indicating a slightly larger deformation (2.64 mm during the impact). The energy absorption was close at 186.51 Joules (J), which implied that the orifice allowed some of the energy to be dissipated differently than in the completely sealed tube, but did not significantly affect the overall energy absorption. However, this could mean that the orifice provided a pathway for the PCM to flow out under impact, reduced the internal pressure and, therefore, better battery protection, meaning that with slightly lower residual displacement, higher energy absorption it provided lower internal pressure thanks to the presence of orifices.

In contrast, the 3.175-50.8-vacant-capped configuration, which was an empty tube with capped ends, showed a decrease in the force peak. This drop indicated that filling the tube with PCM had a significant role in absorbing energy under impact loading. The residual space was 26.89 mm, demonstrating that without PCM, the tube underwent more deformation, leaving less residual space. The energy absorption was lower at 177.36 J, confirming that the PCM-filled tubes enhanced energy absorption.

The 3.175-50.8-vacant-non-capped tube, which was empty and uncapped, exhibited the lowest peak force showed the least resistance to deformation under impact. It also had the most displacement, leaving the least residual space of 14.12 mm. Interestingly, this tube had the highest energy absorption of 192.79 J, which at first seemed counterintuitive. However, this can be explained by the fact that while the force was lower, the larger displacement allowed for a more area under the curve, resulting in higher total energy absorption. Also, the effect of increasing residual displacement by filling with PCM was clearly noticeable in FIG. 34.

The tubes with higher peak forces showed lower displacements and vice versa. The capped tubes exhibited higher forces but lower displacements, whereas the non-capped tube, although demonstrating a lower peak force, compensated with a higher displacement, leading to high energy absorption values across different configurations. This compensatory effect underlined considering both force and displacement in evaluating the energy absorption as well as considering residual space with the objective of protection.

### Example 10

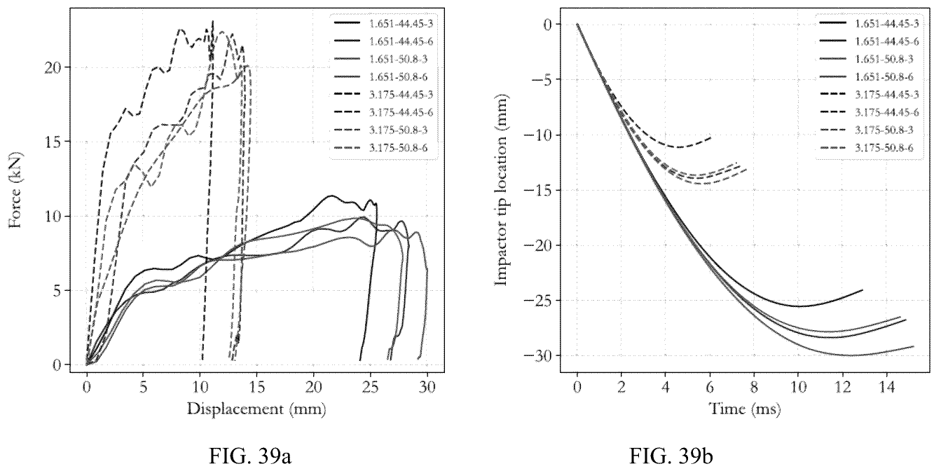

As a continuation of Example 9, the response of PCM-filled tubes to impact loading was evaluated in terms of geometric parameters. The observed data allowed an understanding of how tube thickness, diameter, and orifice size collectively influenced peak force, maximum displacement, energy absorption, and residual space. FIG. 39a presents the force-displacement curves of the main samples, and FIG. 39b illustrates the relationship between impactor tip location and time, effectively displays the maximum displacement of each tube over the duration of the impact.

Thickness played a definitive role in the deformation response of the tubes. Thicker tubes (3.175 mm) yielded significantly lower maximum displacements. For instance, 11.14 mm in 3.175-44.45-3 versus 25.56 mm in 1.651-44.45-3, thus preserving greater internal residual displacement (residual space), such as 26.96 mm versus 15.59 mm, respectively. This implied a more rigid structure that could sustain higher forces with less deformation. Correspondingly, the thicker tubes encountered higher peak accelerations, such as 117.73 g in 3.175-44.45-3, compared to 57.9 g in 1.651-44.45-3, indicating that more contact force was resisted.

Diameter also played a pivotal role in the tube's response to impact loading. Tubes with a smaller diameter demonstrated a mechanical advantage as they produced lower reaction forces due to the reduced distance from the center of impact location to the created plastic hinge, effectively decreasing the bending moment. This phenomenon was consistent with the behavior of circular tubes, confirming the relationship between tube diameter and collapse load. For instance, the smaller diameter tube (3.175-44.45-6) with a maximum displacement of 13.95 mm retained a higher residual space compared to the larger diameter tube (3.175-50.8-6) with a displacement of 14.45 mm, demonstrating the less resistance to lateral collapse in larger tubes.

Orifice size influenced the peak forces. Smaller orifices, by restricting PCM outflow, led to higher forces needed for deformation, reflected in higher peak accelerations like 57.9 g for 1.651-44.45-3 compared to 50.54 g for 1.651-44.45-6. The smaller orifice size resulted in less displacement, as seen with a displacement of 25.56 mm for 1.651-44.45-3 against 28.39 mm for 1.651-44.45-6, thus ensuring more residual space post-impact.

Regarding energy absorption, the values across different configurations were found to be closely ranged, from 186.51 J to 194.53 J. This relative uniformity in energy absorption was attributed to the compensatory nature of the force-displacement relationship; tubes that experienced higher displacements did so at lower peak forces, which, when integrated over the displacement, resulted in similar energy absorption levels. This balance ensured that despite the differences in individual geometric parameters, the overall energy dissipation capability of the tubes remained constant.

Considering all factors, the best-case scenario among the main samples, particularly when emphasizing residual space and energy absorption, was found to be the one with greater thickness (3.175 mm), larger diameter (50.8 mm), and smaller orifice size (3 mm). Although the larger diameter resulted in greater deflection to the tube, the residual space remained larger because the difference between the diameters compensated the difference between deflections. The superior performance of the tube 3.175-50.8-3 was demonstrated by a peak acceleration of 114.21 g, a minimal maximum displacement of 13.67 mm, an energy absorption of 187.35 J, and a residual space of 30.78 mm. This configuration effectively balanced the need for impact resistance with structural integrity, ensuring minimal deformation and efficient energy dissipation.

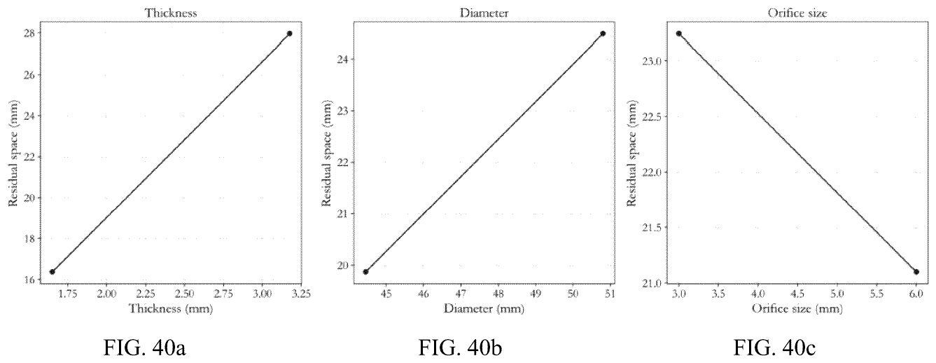

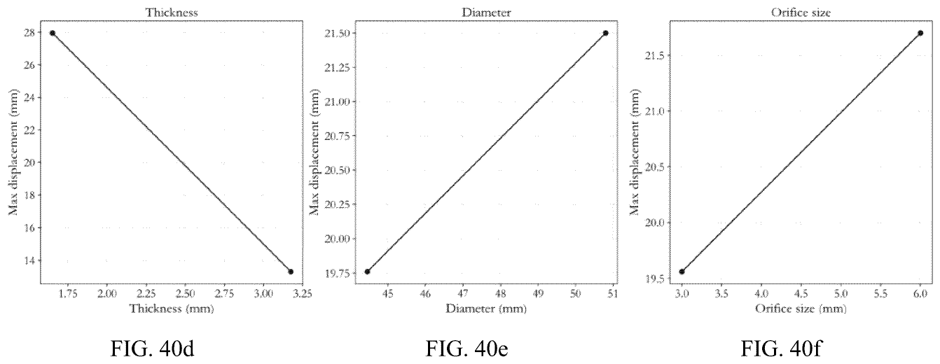

In FIGS. 40a-40f, the average maximum displacement and residual space were represented against various geometric factors, to illustrate their effects. Elevating the thickness from 1.651 to 3.175 mm corresponded to a rise of 11.6 mm in residual space and a reduction of 14.46 mm in maximum displacement. Conversely, decreasing the orifice size from 6 mm to 3 mm resulted in a 2.14 mm increase in residual displacement and an equivalent decrease in maximum displacement. Notably, a modest growth in tube size (diameter) from 44.45 mm to 50.8 mm caused a substantial growth (14.29 mm) in residual space.

In assessing the relative sensitivity of maximum displacement and residual space to changes in each parameter, and under the assumption of a linear relationship between these changes and their outcomes, specific impacts could be deduced from a uniform 10% increase in each parameter. For instance, such an increase in thickness led to a 1.26 mm rise in residual space, while a similar increase in diameter resulted in a 3.23 mm increase. In contrast, a 10% enlargement in orifice size corresponded to a 0.21 mm decrease in residual space. This analysis showed the dominance of diameter, thickness, and orifice size, consequently. In terms of maximum displacement, these changes translated to a 1.59 mm decrease due to increased thickness, a 1.21 mm increase attributed to the larger diameter, and a 0.21 mm increase as a result of the orifice size alteration. This analysis showed the dominance of thickness, diameter and lastly, orifice size on the maximum deflection of the tubes under the impact load.

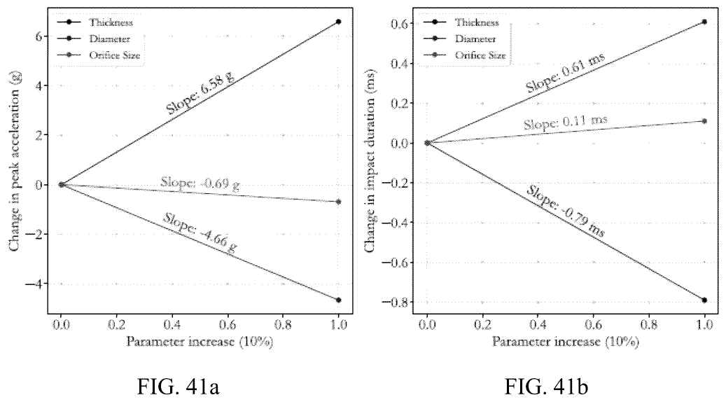

Assuming geometric variations and their effects on peak acceleration and impact duration were linearly related, it is evident in FIGS. 41a-41b that a uniform 10% increase in each parameter produced distinct outcomes. Specifically, the increase in thickness contributed to a 6.58 g increase in peak acceleration, whereas a similar increase in diameter caused a 4.66 g reduction. Likewise, enlarging the orifice led to a 0.69 g decrease in peak acceleration. This demonstrated the primary influence of thickness, diameter, and orifice, respectively.

Concerning impact duration, a 10% increase in thickness resulted in a 0.79 ms decrease, while this increase in diameter and orifice size led to an increase of 0.61 ms and 0.11 ms, respectively. This further indicated the significant role of thickness, followed by diameter and orifice size, in influencing the impact duration.

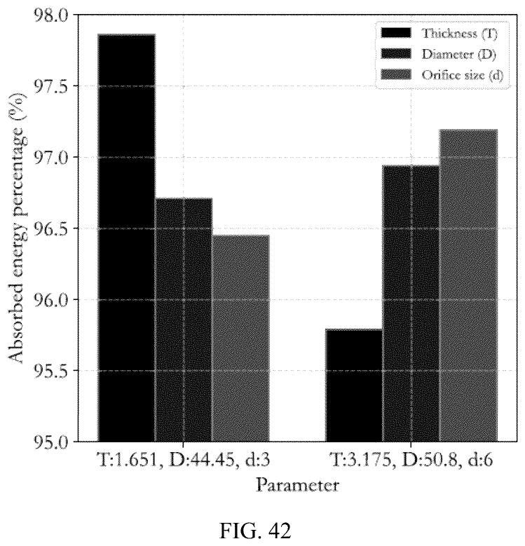

The observed distinction between the kinetic energy of the impactor at impact initiation and the post-rebound energy constituted the absorbed energy. The results were presented as a proportion of the cumulative energy absorbed as a percentage calculated using Equation 16, to the initial kinetic energy. FIG. 42 demonstrates these results. A decrease in overall energy absorption of 2.11% corresponded with an increase in thickness, reducing the percentage from 97.86% to 95.79%. Conversely, increasing the diameter and orifice size had a minor effect on total energy absorption, raised it by 0.24% and 0.77%, respectively. The rise in energy absorption was linked to deflection increase, as shown in FIGS. 40a-40f.

### Example 11

As a continuation of Examples 9 and 10, solutions were investigated to enhance LIB performance under varying temperatures. The focus was on the application of PCMs with expanded graphite (EG) as an additive, aiming to overcome the inherent limitations of LIBs in heat dispersion, particularly at extreme discharge rates.

Paraffin wax (PW; 1500 grams) was placed in a 2000 milliliter (mL) beaker. The beaker was then subjected to a temperature bath filled with mineral water, where the PW was melted at a temperature of 100° C. Subsequently, 100 grams of EG was poured to the melted PW while continuously stirring for a duration of 45 minutes using magnetic stirring on top of a hotplate at 140° C., ensuring thorough mixing and uniformity of the mixture. The weight proportion of EG:PW was chosen based on the fact that composite PCM with a weight ratio of 1:15 (expanded graphite with mass percent of 6.25%) exhibits significantly improved thermal conductivity compared to pure paraffin (see also Yin et al., Experimental research on heat transfer mechanism of heat sink with composite phase change materials, Energy Convers. Manag. 49 (6), 1740-1746, 2008; which is hereby incorporated by reference herein in its entirety).

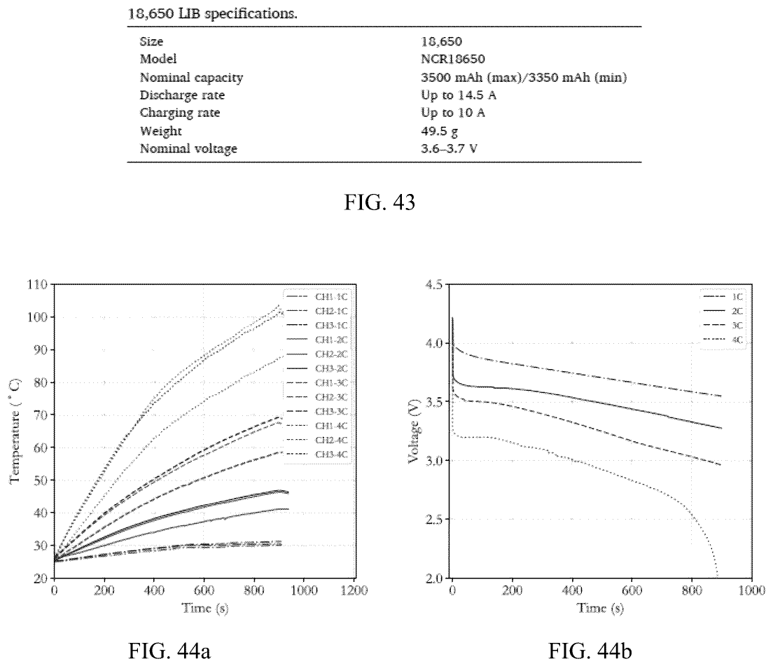

Once the homogeneous mixture was achieved, it was further heated to a temperature of 150° C., allowing it to be easily poured into the experimental samples. After 24 hours of letting them rest at room temperature to ensure solidification, the samples were ready for experiment. The weight of each sample was measured to determine the amount of PCM added, which was 72.1 grams on average. This measurement was obtained by calculating the mass difference of each sample before and after the addition of the PCM/EG composite. An 18,650 LIB was positioned at the center of the sample. Specifications for this battery are outlined in the table shown in FIG. 43. The EG/PW composite filled the empty space around the battery inside a chosen tube sample which was 3.175-50.8-noncapped. Twelve samples (3 identical samples for each discharging rate from 1 C to 4 C) were prepared to check the repeatability and minimize the experimental error. The state of charge of the batteries was 100% before each test.

To analyze the temperature characteristics of the 18,650-battery cell, a temperature control test setup was employed. Three K-Type thermocouple probes, made from glass fiber thread with an exposed contact thermocouple and a standard flat copper plug, were attached to the battery cell at the battery terminals and at the middle of the battery cell. Temperature data from each probe were logged using a multi-channel environment tester equipped with a 4-channel thermocouple thermometer data logger. This device not only ensured accuracy with a resolution of 0.1° C. but also provided real-time data logging capabilities with a connection to a personal computer (PC). Three temperature probes were uniformly distributed along the battery length (one at the beginning of the negative terminal (CH1), one at the middle length of the jellyroll (at 30 mm from the negative terminal) (CH2), and one at the end of jellyroll (5 mm from the positive terminal) (CH3)) while connected to a data logger to record the battery temperatures for each sensor. The ambient temperature was strictly regulated and maintained at 26±0.5° C. for all tests to minimize environmental variability and ensure reproducibility.

The battery was connected to a constant current circuit capable of performing discharging rates ranging from 1 C to 5.7 C (up to 20 Amperes (A) and 100 Watts (W)). This allowed for controlled and consistent discharging of the battery at different rates, enabling the measurement of temperature changes under varying load conditions. The sampling time was set at 900 seconds for all tests to maintain a consistent range across all current rates, given the battery capacity of 3.5 Ampere-hours (A-hr).

In another test configuration, the 18,650 battery was placed inside a composite PCM-filled aluminum tube. This setup aimed to evaluate the effectiveness of the composite PCM in managing and mitigating temperature changes within the battery. The same test setup, including the constant current circuit and the placement of temperature sensors along the battery length, was employed to monitor the battery temperature.

Temperature variation of un-protected batteries is shown in FIG. 44a. The heat transfer test results showed that as the discharging rate rose from 1 C to 4 C, the temperature rise in all the sensors distributed along the length of the battery exhibited a corresponding increase. The temperature rise was found to be more significant in the sensors closer to both battery terminals, indicated that these regions experienced higher heat generation during the discharging process. This temperature nonuniformity along the battery length can potentially lead to localized hotspots and thermal stress, which can negatively impact battery performance and lifespan. Further, as the discharging rate enhanced the uneven temperature distribution increased, too.

In the case of 4 C discharging rate the batteries experienced short-electric circuit as indicated in FIG. 44b at 805 seconds from the onset of the test, and the corresponding voltage dropped considerably which highlighted the above 95° C. as a short circuit criterion.

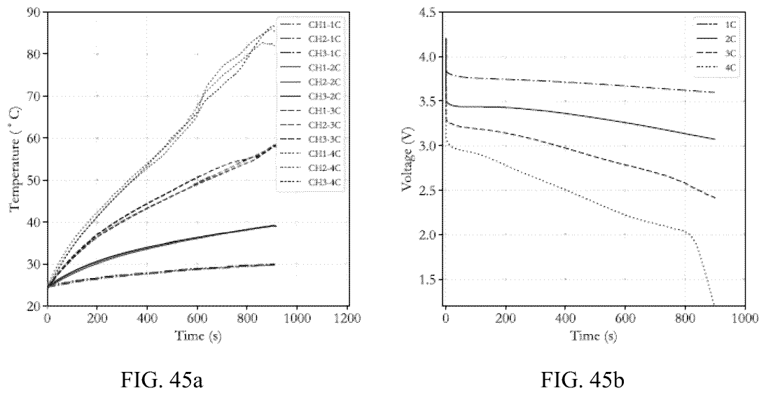

In contrast, when the 18,650 battery was placed inside the aluminum tube filled with the composite PCM, the results revealed temperature regulation throughout the battery as presented in FIG. 45a, where the deviation between the temperature probes for each of discharging rates was notably lower than that of unprotected batteries. Thus, temperature gradient throughout the battery length was considerably controlled indicating the efficient heat dissipation capabilities of the PCM. The PCM effectively absorbed and distributed heat generated during the discharging process, resulting in reduced temperature rises across all the sensors. Upon analyzing the maximum temperatures at identical discharging rates for both protected versus unprotected batteries, a noticeable decrease in temperature was observed, with reductions of 1.4, 7.78, 11, and 16.8° C. for discharging rates from 1 C to 4 C, respectively.

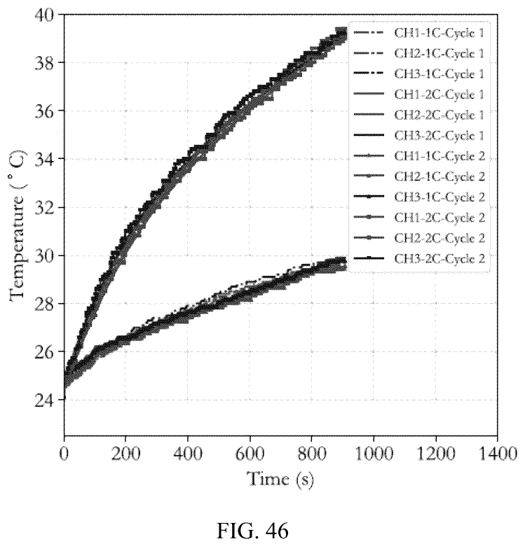

Further, to validate the composite PCM efficacy in managing recurrent temperature variations, a follow-up experiment was conducted on the same battery after an interval, ensuring its initial temperature mirrored that of the first cycle. The outcomes of this test are depicted in FIG. 46, which juxtaposes the battery temperatures from the first and subsequent cycle for 1 C and 2 C discharging rates. FIG. 46 demonstrates a striking congruence between the two cycles, thereby affirming the composite PCM consistent performance and reliability across multiple uses.

### Example 12

As a continuation of Examples 9-11, numerical simulations were run. The impact loading on PCM-filled aluminum capped-end thin-walled shells could be categorized as a highly coupled semifluid-structure interaction. Following the impact, the confined PCM experienced a rapid pressure distribution, resulting in the transmission of pressure pulses throughout the paraffin wax within the impacted region. Although turbulent flow was unlikely due to the semifluid nature of the medium and the absence of projectile penetration, the semifluid material underwent significant deformation, requiring special considerations for numerical modelling.

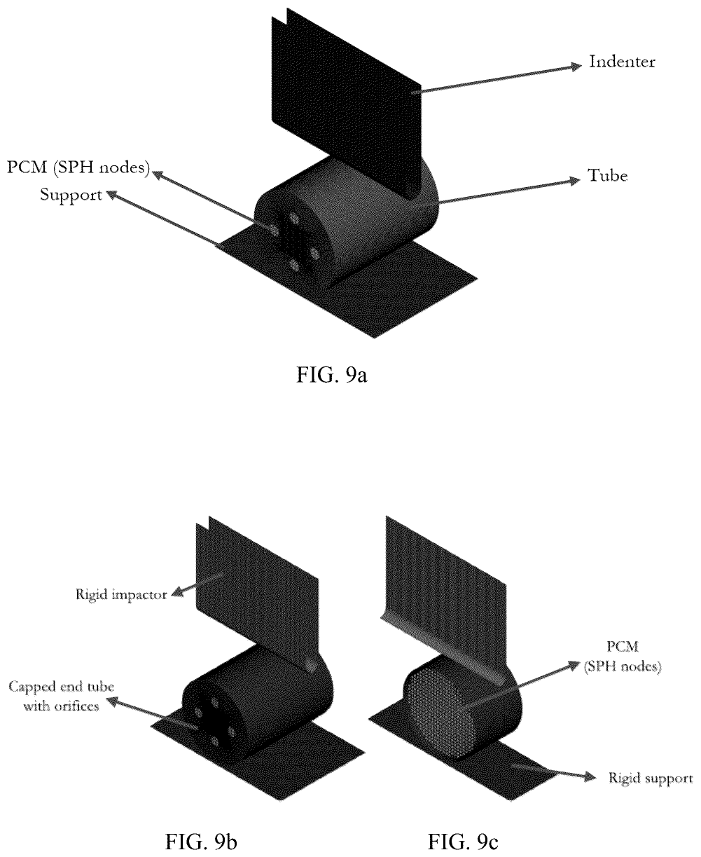

The samples were modeled using finite element (FE) methods, as shown in FIGS. 9b and 9c. The tube was modeled using shell elements in Lagrangian formulation that incorporated capabilities for significant plastic deformation. To simulate the effect of the semi-solid material, an advanced method called smoothed-particle hydrodynamics (SPH) was utilized to model the squeezable material. To improve computational efficiency, a simplifying assumption was made regarding the impactor. It was simulated as a rigid shell with a hemicylindrical head and dimensions in accordance with the impactor in experiments. Automatic_surface_to_surface contact was employed to consider the response forces in indenter-tube, as well as in tube-support. In the LS-Dyna software, interaction between the SPH nodes and the tube elements were conducted using the node_to_surface contact keyword. For the indenter, initial velocity was defined to replicate the experimentally observed velocity at the onset of impact (4.43 meters per second (m/s)), while the support was fully fixed in place. Also, whole parts were under a global gravitational load with acceleration of 9.81 m/s².

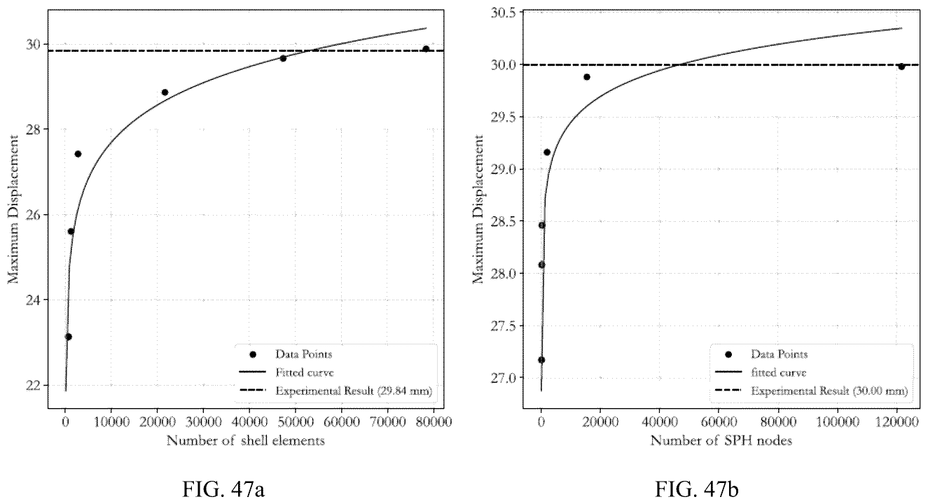

To examine the influence of element size on the simulation, a mesh convergence study was conducted for both the shell and SPH domains. FIGS. 47a and 47b illustrate the relation between the mesh size and the maximum deflection of tubes at the impact location. The analysis was carried out for both an empty sample (to find the mesh convergency for Lagrangian medium) and a PCM filled sample (for SPH medium), specifically using a sample with the code 1.651-50.8-vacant-capped and 1.651-50.8-6. Through careful refinement of the model discretization, a clear independence from the mesh size was observed for both the SPH and Lagrangian domains. Considering computational costs and convergence, a shell element size of 0.64 mm and SPH node spacing of 2 mm were implemented in the domains.

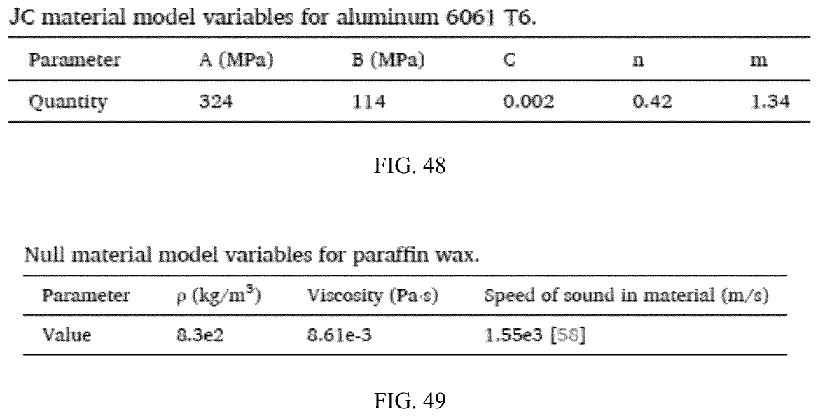

The mechanical behavior of aluminum 6061 T6 was simulated employing a material model called 015_Johnson_Cook (JC), a well-established material formulation for ductile metals in LS-Dyna. The JC plasticity model accounts for the hardening constitution, strain rate and temperature sensitivity, all of which are expressed mathematically in Equation 17 (see also, Johnson, A constitutive model and data for materials subjected to large strains, high strain rates, and high temperatures, in: Proc. 7th Inf. Sympo. Ballist, pp. 541-547, 1983; which is hereby incorporated by reference herein in its entirety). Equation 17 relates stress (σ) to strain (ε), strain rate (ε(dot)), and temperature (T). The first set of parentheses represents the stress-strain relationship, while the second set characterizes the effect of strain rate on the yielding threshold. Additionally, temperature affects the yield stress, as shown in the third set of parentheses. The table in FIG. 48 presents the quantities used in LS-Dyna (see also, Lesuer et al., Modeling Large-strain, High-rate Deformation in Metals, Lawrence Livermore National Lab. (LLNL), Livermore, CA (United States), 2001; which is hereby incorporated by reference herein in its entirety).

$$σ = ( A + B {ε}^{n} ) ( 1 + C ln \frac{\dot{ε}}{\dot{{ε}_{0}}} ) ( 1 - {( \frac{{T}^{*} - {T}_{room}}{{T}_{melt} - {T}_{room}} )}^{m} ) \qquad ( 17 )$$

For simulating the PCM material, the 009_NULL material model in LS-Dyna was employed, along with the Gruneisen equation of state (EOS) using the parameters provided in in the table in FIG. 49. It is worth noting that the material density and dynamic viscosity values were obtained from the manufacturer.

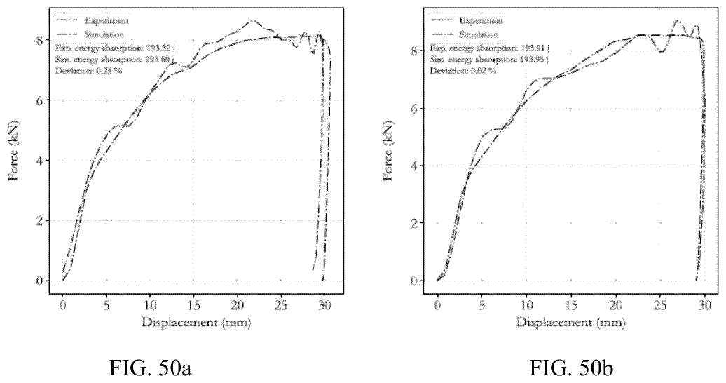

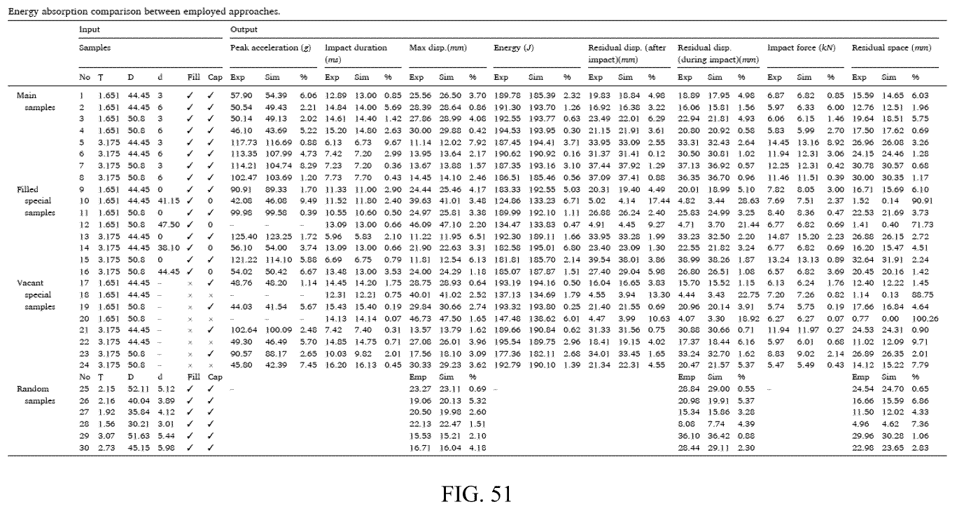

The visual validation of the numerical technique and its agreement with experimental testing showcased the indented empty and filled tubes. FIGS. 50a and 50b display the consistency between the force-deflection curves obtained from FE simulation and experimental data for 1.651-50.8-vacant-capped (as a validation of aluminum 6061 T6 material model) and 1.651-44.45-6 (as a validation of PCM material model) subjected to the impactor. The simulated result accurately predicted the occurrence of buckling, peak force, impact duration and maximum deflection aligning closely with the experimental findings as compared in the table shown in FIG. 51. The peak accelerations for some samples were not reported, due to the impactor tip passing the sample full diameter, causing significantly high acceleration values indicative of a hard impact. The dynamic testing outcomes exhibited deviations of mostly less than 5% and in some minor cases less than 10% compared to corresponding computational models. The minor deviations can be attributed to contact definition, coefficient of friction, and slide occurring at the impact zone, as well as fluctuations of acceleration values and noise interrupting data logging and not ideally filling the samples with the PCM material which could have resulted in void spaces in the samples.

### Example 13

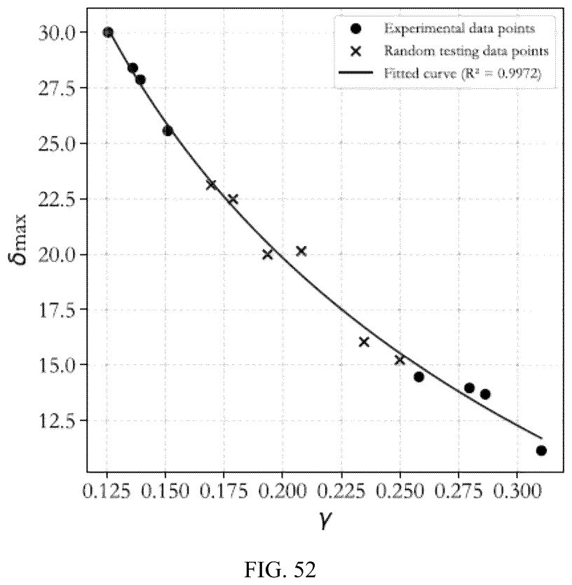

As a continuation of Examples 9-12, having established the validity and precision of the numerical model in Example 12, these findings were extended by developing an empirical approach. This approach is designed to estimate maximum displacement, using the data and understandings derived from the FE analysis. The following steps were undertaken to obtain Equation 19. First, the correlation between the parameters (T, D and d) and maximum deflection (δmax) was determined by systematically designing cases and analyzing the ascending or descending slope of the correlation, as FIGS. 40a-40f depicted. These relationships were then incorporated into the formulation by placing them as numerator or denominator in the γ formulation that incorporate geometric variables, as appropriate. Then, ascending functions, as defined in Equation 18, were applied to each parameter to create a curve that best fit the actual results and validated FE outcomes. In order to fit the curve, curve fitting tool in MATLAB was used, aiming for a close to one (0.9972 in this case) coefficient of determination (R2), as shown in FIG. 52. Last, the equation representing the fitted curve was obtained and is presented in Equation 19. This equation encapsulates the empirical formulation for predicting the maximum deflection based on the fitted curve.

$$γ = \frac{{T}^{1.1}}{{D}^{0.6} \times {d}^{0.15}} \qquad ( 18 )$$

$${δ}_{max} = 63.2551 {e}^{- {24.5763}_{γ}} + 48.6373 {e}^{- {4.6034}_{γ}} \qquad ( 19 )$$

The empirical formulation was validated through the table in FIG. 51, where the deviation in results from empirical approach and outcomes for the samples with randomly chosen parameters, was determined to be less than 6%.

To validate the mechanical characteristics used in FE simulation and ensure the precision of the empirical equation, a diverse range of random samples was simulated as shown in FIG. 52 along with the experimental results. The verified mechanical characteristics were used as the basis for the modeling, which agreed with the experimental findings.

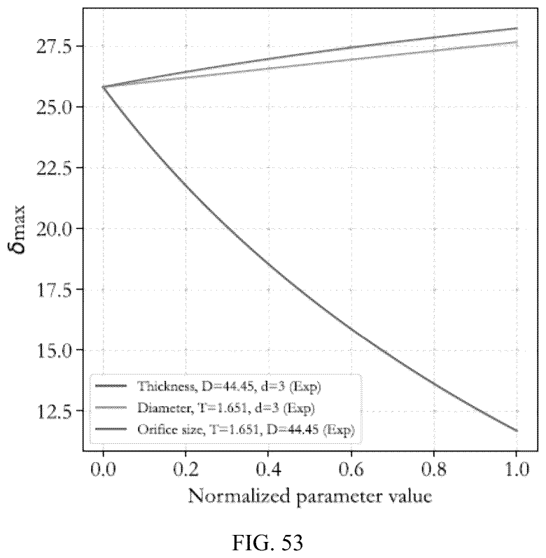

The impact of tube thickness, diameter, and orifice size on maximum deflection is presented in FIG. 53. The x-axis of the graph represents the range of the experimental values for each parameter, where a value of 0 for thickness corresponded to 1.651 mm and a value of 1 represented 3.175 mm. Similarly, the diameter ranged from 44.45 mm to 50.8 mm, and the orifice size ranged from 3 mm to 6 mm. To ensure comparability, all maximum deflections were standardized through dividing them by their respective utmost values. The experimental results were interpolated using Equation 19, with a reference specimen considered for every data points, which was 1.651-44.45-3. Consequently, for the curve associated with the thickness, the orifice and diameter remained constant while the thickness varied and same went for the other curves in FIG. 53.

With an increase in the diameter of tube, the maximum deflection decreased. The reaction forces were lower in tubes with larger diameter because they were less resistant to lateral collapse. The curve illustrating the relationship between diameter and maximum deflection revealed that larger samples exhibited greater deflection, while decreasing the size of the orifices resulted in an increase in the force necessary to expel the PCM, decreasing the maximum deflection. Consequently, this led to an improvement in residual space. This is all in agreement with what was discussed in Example 10 as the results for experimental tests.

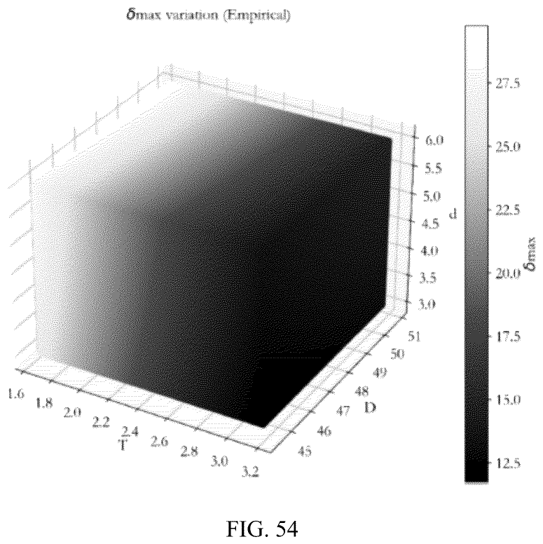

The variation in maximum deflection with respect to geometric factors is depicted in FIG. 54. To achieve minimal deflection, the design incorporated the minimum feasible diameter and orifice size, while ensuring the thickness remained at the maximum value possible. This was while the maximum residual space was achievable when the minimum orifice size was selected along with the maximum diameter and the tube thickness, because the increase in diameter has a greater impact on residual space than the increase in deflection caused by larger diameter, as compared in the table in FIG. 51.

### Example 14

As a continuation of Examples 9-13, an analysis was performed to understand the impact of mechanical stresses on 18,650 LIBs. It is noted that previous examples focused on the structural integrity of EV battery cells, modules, and pack, highlighting the role of thin-walled aluminum tubes and PCM in enhancing battery safety. The analysis in this example is important, given that mechanical stresses, including compression and indentation, can severely compromise battery safety. By examining the response of 18,650 LIBs to these specific stressors, a more comprehensive understanding of battery safety can be obtained, addressing a key aspect that complements the previous examples related to structural and thermal aspects.

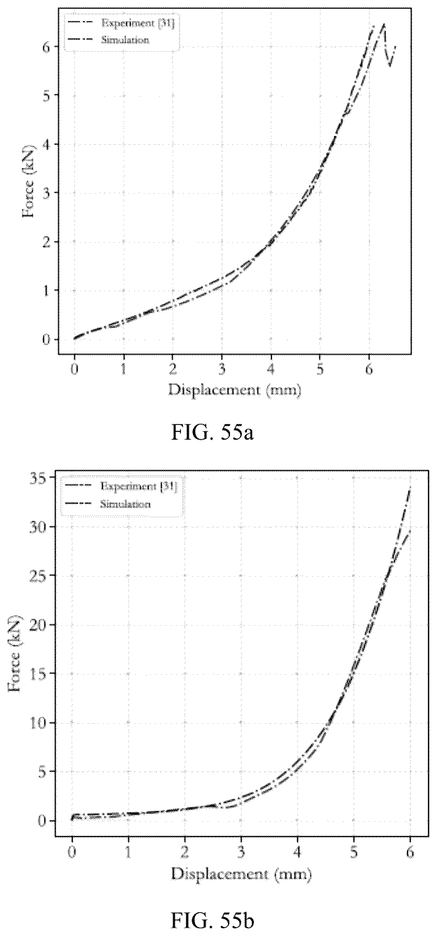

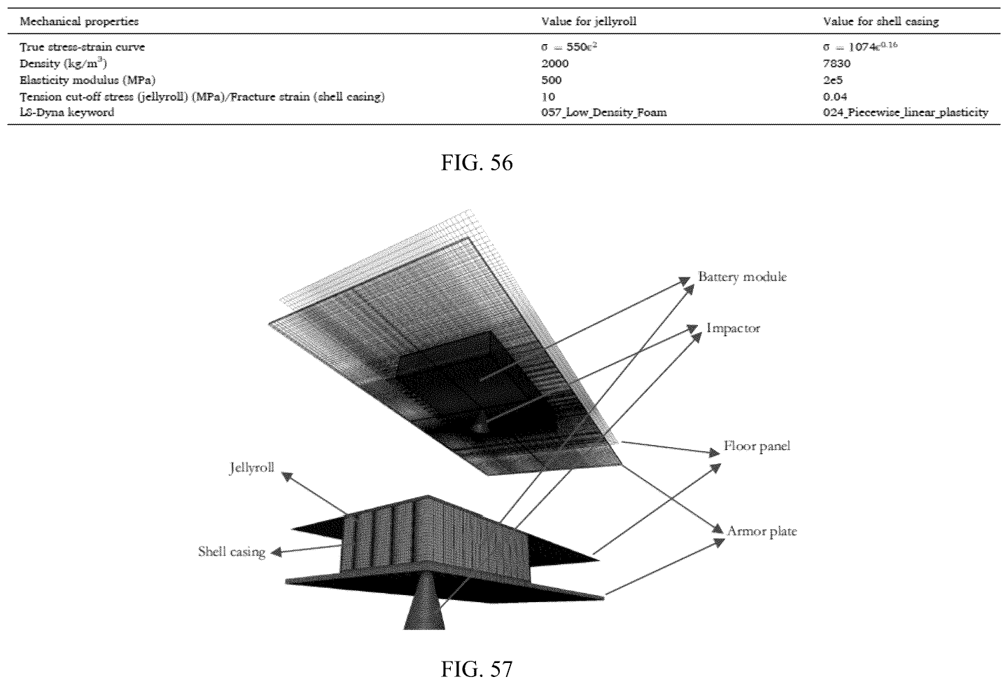

Sahraei et al. provide an extensive series of abuse tests on 18,650 LIBs, which was employed in this analysis to investigate mechanical battery behavior under indentation and compression (see Sahraei et al., Modeling and short circuit detection of 18650 Li-ion cells under mechanical abuse conditions, J. Power Sources 220, 360-372, 2012; which is hereby incorporated by reference herein in its entirety). The force-displacement curve obtained from simulating the battery cell under displacement control condition under indentation and compression tests exhibited a remarkable agreement with the test results, validating its potential for assessing battery safety under mechanical abuse conditions, as shown in FIGS. 55a and 55b. The simulation involved the utilization of the same geometric parameters and boundary conditions as described in Sahraei et al. using the material mechanical properties noted in the table in FIG. 56.

To accurately predict the mechanical response of battery cells under varied loading conditions, it was essential to establish an appropriate constitutive model for the jelly roll component. In this context, two primary modeling strategies were conceivable. The first involved treating the jelly roll as a laminated composite, where material characteristics were derived from the properties of individual layers comprising active electrodes, electrode collectors, and separators. Alternatively, the jelly roll could be modeled as a homogenized entity, where properties were determined through empirical testing on entire cells. For the purposes of this study, the latter approach was selected due to its efficiency in model development and finite element simulation processes. This method also reliably predicted cell behavior, including critical outcomes like the onset of short circuits.

The internal components of the battery were simulated using the representative volume element (RVE) method, which is employed for modeling the behavior of batteries. The RVE refers to the minimum volume element of the material that, upon evaluation, exhibits the full spectrum of macroscopic properties inherent to the bulk material. For the jellyroll structure, the RVE comprised dual layers of active substance, a pair of graphite layers, two separator sheets, along with a sheet of copper and aluminum foil. RVE models have been developed based on this fundamental structure for a range of different kinds of batteries, including pouch and 18,650 tubular batteries. Compared to more detailed models, the RVE approach offers computational advantages, making it suitable for full-scale simulations involving battery modules, packs, and car crashes.

This simplification was based on the suggestion that the material of the jelly roll exhibits a compressible foam-like behavior prior to reaching densification. For the shell casing, a discretization technique employing 4-node fully integrated shell elements was employed. Meanwhile, the jelly roll was captured through the use of fully integrated solid elements. The finite element mesh comprised 48,360 shell elements and 117,800 solid elements, with a near-uniform element size of 0.3 mm, to ensure a consistent resolution across both the casing and the jelly roll.

The following work was the validation of a battery pack under impact load using identical conditions to those of Xia et al. (supra.). An objective of this analysis centered on the mechanical properties of battery packs, underscoring the need for design strategies when incorporating these packs into electric vehicles. Further, this analysis highlighted the importance of fracture analysis, presenting it as an essential element in the design process to ensure the structural integrity and enhanced safety of battery packs. FIG. 57 presents an isometric perspective and a sectional view of the simulated assembly. It also includes the depiction of a rigid conical impacting mass.

The modeling primarily encompassed major structural elements of the battery pack and shields, encompassing the casing of the shell, the coiled layers of individual cells, the housing of the battery module, and the protective armor and base plates. The simplified model of the battery pack narrowed the scenario of impact to concentrate on a solitary battery module. The module was enclosed by 3 mm thick plastic plates (polypropylene), represented using solid elements. The module contained approximately 400 vertically oriented 18,650 LIB cells, as depicted in FIG. 57. Battery cells were in direct contact with six neighboring cells, excluding those at the outermost edges of the stack.

The battery cells within the pack adhered to standard specifications, with 65 mm height and 18 mm diameter. Battery cells featured a thin shell casing surrounding the jellyroll. The shell casing, had a mean thickness of 0.2 mm. The homogenized jellyroll was modeled using solid elements.

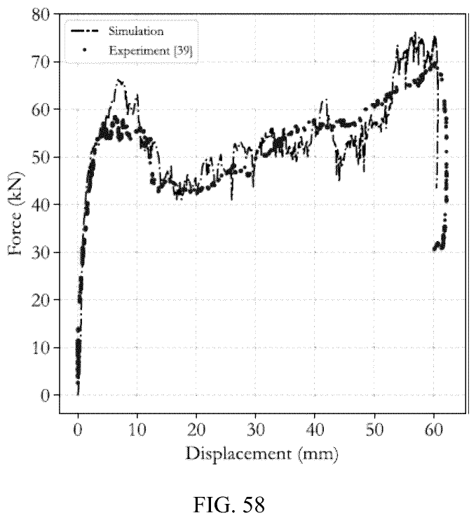

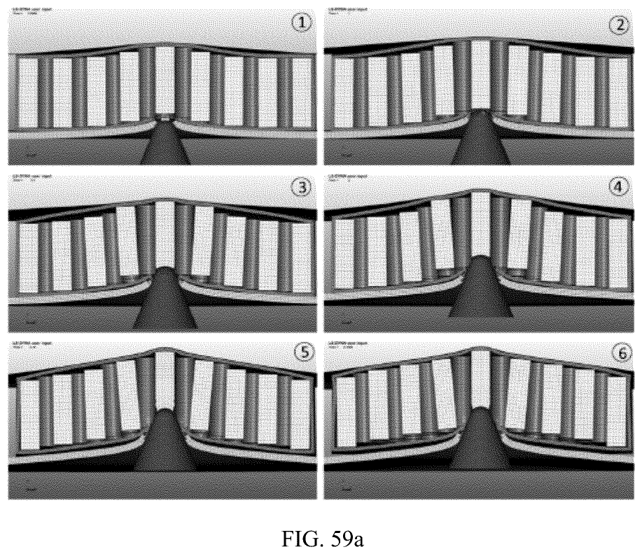

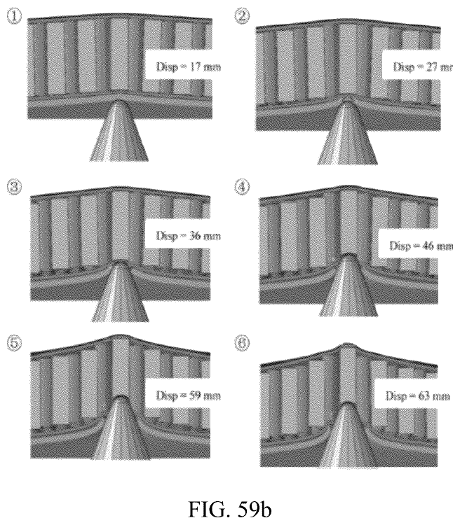

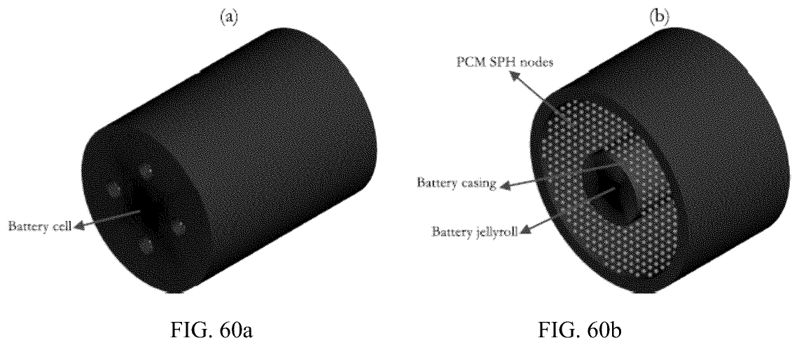

The impactor had a mass of 7.5 kilograms (kg) with a velocity of 30 m/s. The LS-Dyna simulation accurately replicated the dynamic impact scenario, producing congruent results with the reference case. The force versus displacement graph derived from the computational model closely matched the observed progression of the fracture sequence within the battery pack structure, including the fracture of various components, as depicted in FIG. 58. Further, visual validation of the impact during the whole penetration with respect to time is shown in FIG. 59a.

A comprehensive analysis of the battery protection system performance was performed, building on the findings discussed above. This analysis helped get a closer look at how effective embodiments of the subject invention can be in safeguarding an integrated battery cell that was placed along the tube longitudinal axis and centered within the tube, as illustrated in FIGS. 27a and 27b. A specific sample was focused on, with dimensions of 3.175-50.8-3.

The analysis involved simulating an impact load scenario, using an impactor weighed 20 kg at a speed of 4.43 m/s. The geometrical parameters of the indenter were the same as what introduced in Example 12. To ensure the simulations captured the interactions between the battery tips and the tube caps accurately, the tube was modeled using solid elements and it was ensured that at least four elements were used through the thickness direction of the tube.

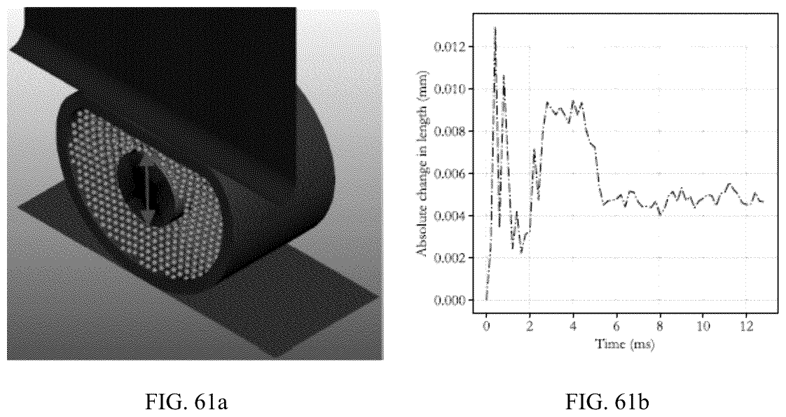

As illustrated in FIG. 61a, the deflected sample configuration is shown at the onset of maximum indentation by the impactor. Remarkably, no intrusion into the battery casing was observed in this configuration, highlighting the exceptional performance of the battery protection system against such impact scenarios. Further, an analysis was conducted by tracking the distance of two nodes located at the ends of a diameter on cross-section of battery casing, positioned in the middle of the battery length. The absolute change history of this distance is recorded in FIG. 61b, which shows that there was only a maximum of 13 μm change in the diameter of the battery casing at the midpoint. Notably, this value is substantially lower than the battery short-circuits criterion of 6.3 mm under indentation.

A comparative analysis was conducted between protected and unprotected batteries within battery modules, focusing on their performance under side pole impact. The analysis utilized a simulation of a light-weight vehicle modeled by the National Crash Analysis Centre at the George Washington University, in collaboration with the Federal Highway Administration and the National Highway Traffic Safety Administration (Marzougui et al., Development and validation of a finite element model for a mid-sized passenger sedan, in: Proceedings of the 13th International LS-DYNA Users Conference, pp. 8-10. Dearborn, MI, USA, 8-10 Jun. 2014; which is hereby incorporated by reference herein in its entirety). To ensure accuracy, the collision was performed in accordance with the FMVSS214 standard, which specifies the impact conditions for side pole tests (see also N. H. T. S. Administration, Federal motor vehicle safety standards; side impact protection; side impact phase-in reporting requirements; proposed rule, Fed. Regist. Part IV, Dep. Transp. 49, 2004; which is hereby incorporated by reference herein in its entirety).

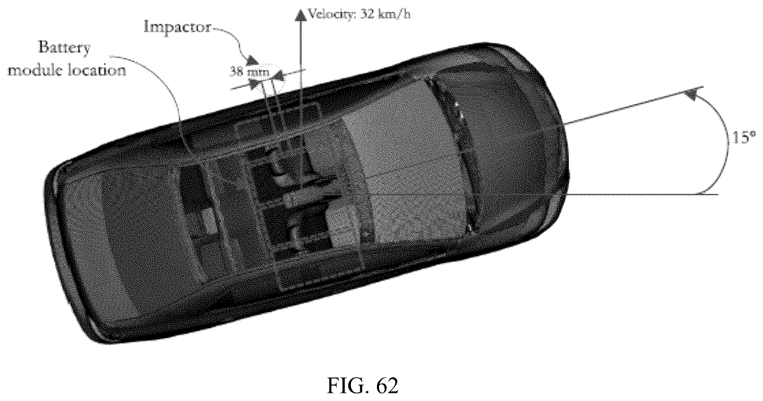

The test employed a 254 mm diameter rigid pole and set the vehicle velocity at 32 kilometers per hour (km/h) (=8.9 m/s) with a 15-degree deviation in the velocity vector with respect to the impact direction. It was assumed that there was a negligible frictional coefficient in contact between tires-ground. As per FMVSS214 guidelines, the impactor center line should be positioned 38 mm longitudinally ahead of the center of the dummy head. The simulation setup and the location of the battery modules are depicted in FIG. 62, with four battery modules aligned in the direction of side impact and placed on the vehicle floor.

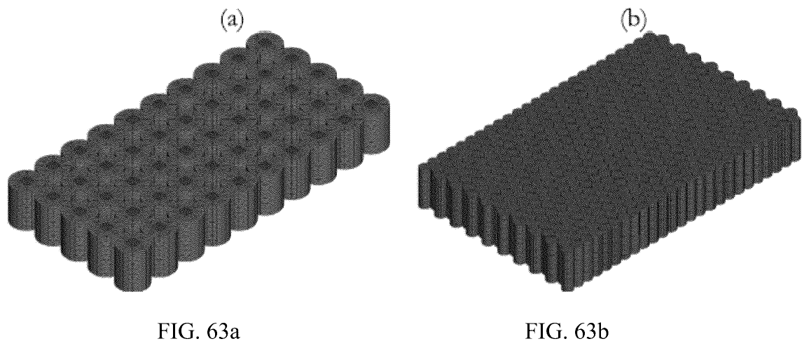

The protected batteries were enclosed in aluminum capped end tubes filled with PCM, as illustrated in FIG. 63a. In contrast, the unprotected batteries lacked this protective feature, as shown in FIG. 63b. During the simulation, the lateral deflection experienced by the batteries was examined and the results were compared to the battery cell in the worst-case scenarios for protected and unprotected battery module.

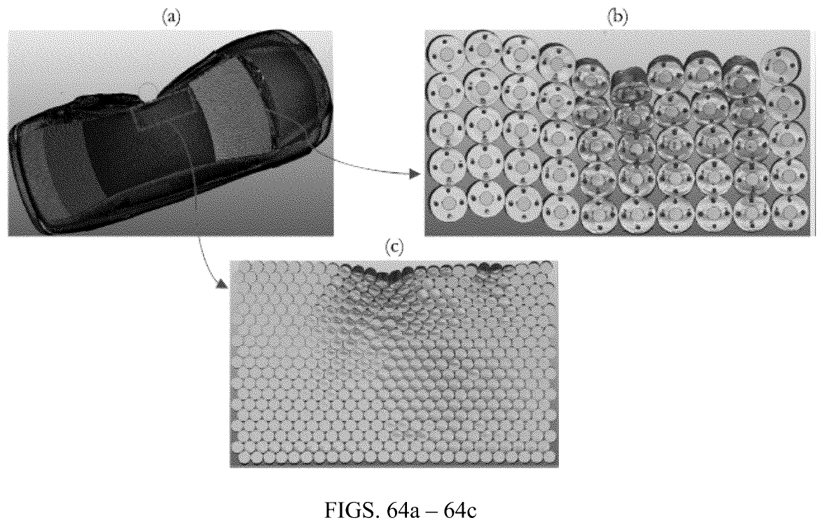

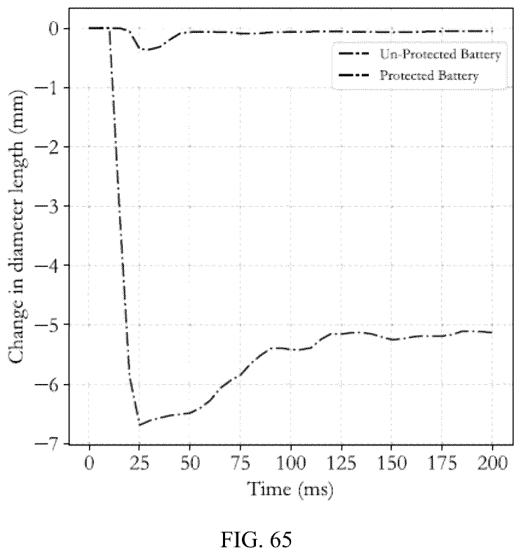

The two battery cells that were located at the closest distance to the location of impact were analyzed regarding the change in the distance of two nodes on two sides of a cross-sectional diameter. As indicated visually in FIGS. 64a and 64b and numerically in FIG. 65, the protected batteries demonstrated less than 0.35 mm indentation, which is negligible with respect to the short circuit criterion (6.3 mm according to Sahraei et al. (supra.)). On the other hand, the unprotected batteries exhibited lateral deflection of 6.69 mm, surpassing the threshold for short circuits in 18,650 LIBs. This comparison highlights the critical role of protective measures in enhancing battery safety during side pole impacts.

Embodiments of the subject invention provide multifunctional battery modules to enhance the battery safety under impact loading and keep the battery temperature in its high-performance range. The examples, particularly Examples 9-14, provide in-depth investigation through a combination of experiments, numerical simulations, empirical approaches, and comparative analyses. The mechanical and thermal safety enhancement of EV batteries was achieved, focusing on the use of thin-walled metallic tubes as energy absorbers and the incorporation of PCMs for thermal management. The experimental results have provided significant insights into the efficiency and practicality of these approaches.

The findings include those related to safety enhancements, thermal management, geometric effect, simulation accuracy, and protection effectiveness. With respect to safety enhancement, the effectiveness of thin-walled metallic tubes as energy absorbers in enhancing mechanical safety was demonstrated, with a 3.175-50.8-3 (thickness-diameter-orifice size, all in mm) tube configuration absorbing 187.35 J, representing 95.47% of the impactor's kinetic energy, and maintaining significant residual displacement (30.78 mm). This setup effectively minimized battery damage during impact scenarios. With respect to thermal management, incorporating composite PCM-based thermal management systems proved essential for regulating battery temperatures and preventing thermal runaway. The PCM-encased batteries maintained lower and more uniform temperatures compared to unprotected ones, especially noticeable during high discharge rates. With respect to geometric effect, the findings highlighted the influence of tube thickness, diameter, and orifice size on safety. For instance, with a thickness increase from 1.651 mm to 3.175 mm, residual space was enhanced by 11.6 mm and maximum displacement was reduced by 14.46 mm. These parameters were crucial for maximizing battery protection. With respect to simulation accuracy, numerical simulations using FE methods accurately replicated real-world behaviors, supported by material constitutive equations for aluminum 6061 T6 and paraffin wax. The simulations showed a high degree of precision, with force-deflection curves aligning closely with experimental outcomes. With respect to protection effectiveness, comparative analyses of protected versus unprotected battery setups under side-pole impacts validated the protective efficacy of embodiments of the subject invention. Protected batteries showed negligible indentation, significantly within safety thresholds, demonstrating the critical role of safety enhancements in real-world conditions.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including in the “References” section, if present) are incorporated by reference in their entirety, including all figures and tables, to the extent they are not inconsistent with the explicit teachings of this specification.

### REFERENCES

[1] J. M. Alexander, “An Approximate Analysis Of The Collapse Of Thin Cylindrical Shells Under Axial Loading,” Q. J. Mech. Appl. Math., vol. 13, no. 1, pp. 10-15, January 1960, doi: 10.1093/qjmam/13.1.10.
[2] W. Abramowicz and N. Jones, “Dynamic axial crushing of circular tubes,” Int. J. Impact Eng., vol. 2, no. 3, pp. 263-281, 1984.
[3] T. Wierzbicki and S. U. Bhat, “A moving hinge solution for axisymmetric crushing of tubes,” Int. J. Mech. Sci., vol. 28, no. 3, pp. 135-151, 1986.
[4] K. R. F. Andrews, G. L. England, and E. Ghani, “Classification of the axial collapse of cylindrical tubes under quasi-static loading,” Int. J. Mech. Sci., vol. 25, no. 9, pp. 687-696, 1983, doi: https://doi.org/10.1016/0020-7403 (83) 90076-0.
[5] N. Yob, K. A. Ismail, M. A. Rojan, M. Z. Othman, and A. M. A. Zaidi, “Quasi Static Axial Compression of Thin Walled Aluminum Tubes: Analysis of Flow Stress in the Analytical Models,” Mod. Appl. Sci., vol. 10, no. 1, p. 34, 2016.
[6] S. Li, X. Guo, Q. Li, D. Ruan, and G. Sun, “On lateral compression of circular aluminum, CFRP and GFRP tubes,” Compos. Struct., vol. 232, p. 111534, 2020.
[7] N. K. Gupta, G. S. Sekhon, and P. K. Gupta, “Study of lateral compression of round metallic tubes,” Thin-walled Struct., vol. 43, no. 6, pp. 895-922, 2005.
[8] S. Santosa and T. Wierzbicki, “Effect of an ultralight metal filler on the bending collapse behavior of thin-walled prismatic columns,” Int. J. Mech. Sci., vol. 41, no. 8, pp. 995-1019, 1999.
[9] A. Niknejad, S. A. Elahi, and G. H. Liaghat, “Experimental investigation on the lateral compression in the foam-filled circular tubes,” Mater. Des., vol. 36, pp. 24-34, 2012, doi: https://doi.org/10.1016/j.matdes.2011.10.047.
[10] Z. Liu, Z. Huang, and Q. Qin, “Experimental and theoretical investigations on lateral crushing of aluminum foam-filled circular tubes,” Compos. Struct., vol. 175, pp. 19-27, 2017.
[11] Y. Gan, J. Wang, J. Liang, Z. Huang, and M. Hu, “Development of thermal equivalent circuit model of heat pipe-based thermal management system for a battery module with cylindrical cells,” Appl. Therm. Eng., vol. 164, p. 114523, 2020.
[12] Y. Zhou et al., “Recent advances in organic/composite phase change materials for energy storage,” ES Energy Environ., vol. 9, no. 8, pp. 28-40, 2020.
[13] Y. Ganatra and A. Marconnet, “Passive Thermal Management Using Phase Change Materials: Experimental Evaluation of Thermal Resistances,” in International Electronic Packaging Technical Conference and Exhibition, 2015, vol. 56888, p. V001T09A064.
[14] N. Javani, I. Dincer, G. F. Naterer, and G. L. Rohrauer, “Modeling of passive thermal management for electric vehicle battery packs with PCM between cells,” Appl. Therm. Eng., vol. 73, no. 1, pp. 307-316, 2014.
[15] W. Q. Li, Z. G. Qu, Y. L. He, and Y. B. Tao, “Experimental study of a passive thermal management system for high-powered lithium ion batteries using porous metal foam saturated with phase change materials,” J. Power Sources, vol. 255, pp. 9-15, 2014.
[16] Y. Zhang, J. Huang, M. Cao, G. Du, and Z. Liu, “A novel sandwich structured phase change material with well impact energy absorption performance for Li-ion battery application,” J. Energy Storage, vol. 40, p. 102769, 2021.
[17] S. Akram, S. H. I. Jaffery, M. Khan, M. Fahad, A. Mubashar, and L. Ali, “Numerical and experimental investigation of Johnson-Cook material models for aluminum (Al 6061-T6) alloy using orthogonal machining approach,” Adv. Mech. Eng., vol. 10, no. 9, p. 1687814018797794, 2018.
[18] E. Morris, A. G. Olabi, and M. S. J. Hashmi, “Lateral crushing of circular and non-circular tube systems under quasi-static conditions,” J. Mater. Process. Technol., vol. 191, no. 1-3, pp. 132-135, 2007.
[19] E. Morris, A.-G. Olabi, and M. S. J. Hashmi, “Analysis of nested tube type energy absorbers with different indenters and exterior constraints,” Thin-walled Struct., vol. 44, no. 8, pp. 872-885, 2006.
[20] J. Zhu, X. Zhang, E. Sahraei, and T. Wierzbicki, “Deformation and failure mechanisms of 18650 battery cells under axial compression,” J. Power Sources, vol. 336, pp. 332-340, 2016.
[21] D. K. Rajak, L. A. Kumaraswamidhas, and S. Das, “An energy absorption behaviour of foam filled structures,” Procedia Mater. Sci., vol. 5, pp. 164-172, 2014.
[22] G. Sun, D. Chen, G. Zhu, and Q. Li, “Lightweight hybrid materials and structures for energy absorption: A state-of-the-art review and outlook,” Thin-Walled Struct., vol. 172, p. 108760, 2022.
[23] G. R. Johnson, “A constitutive model and data for materials subjected to large strains, high strain rates, and high temperatures,” Proc. 7th Inf. Sympo. Ballist., pp. 541-547, 1983.
[24] D. R. Lesuer, G. J. Kay, and M. M. LeBlanc, “Modeling large-strain, high-rate deformation in metals,” Lawrence Livermore National Lab. (LLNL), Livermore, CA (United States), 2001.
[25] H. K. H. Kamioka, “Ultrasonic Behaviour of Paraffin Wax during Melting and Solidification Processes,” Jpn. J. Appl. Phys., vol. 33, no. 5S, p. 2908, 1994.
[26] A. Baroutaji, E. Morris, and A.-G. Olabi, “Quasi-static response and multi-objective crashworthiness optimization of oblong tube under lateral loading,” Thin-Walled Struct., vol. 82, pp. 262-277, 2014.
[27] G. Lu and T. X. Yu, Energy absorption of structures and materials. Elsevier, 2003.
[28] D. S. Dugdale, “Viscous flow through a sharp-edged orifice,” Int. J. Eng. Sci., vol. 35, no. 8, pp. 725-729, 1997.
[29] B. W. Barry and A. J. Grace, “Rheological properties of white soft paraffin,” Rheol. acta, vol. 10, no. 1, pp. 113-120, 1971.

What is claimed is:

1. A system for protecting batteries, the system comprising:
a plurality of tubes configured to be disposed around the batteries, respectively,
wherein each tube of the plurality of tubes comprises a phase change material (PCM) disposed therein,
wherein each tube of the plurality of tubes comprises a first cap on a first end thereof, and
wherein the first cap comprises at least one first orifice.

2. The system according to claim 1, wherein each tube of the plurality of tubes further comprises a second cap on a second end thereof.

3. The system according to claim 1, wherein the at least one first orifice comprises at least four first orifices.

4. The system according to claim 3, wherein a largest dimension of each first orifice is in a range of from 2 millimeters (mm) to 6 mm.

5. The system according to claim 2, wherein the second cap comprises at least one second orifice.

6. The system according to claim 5, wherein the at least one second orifice comprises at least four second orifices, and
wherein a largest dimension of each second orifice is in a range of from 2 mm to 6 mm.

7. The system according to claim 1, wherein each tube of the plurality of tubes comprises aluminum.

8. The system according to claim 1, wherein each tube of the plurality of tubes is a cylindrical-shaped tube, and
wherein each tube of the plurality of tubes is completely filled with the PCM in an axial direction of the tube and completely filled with PCM around the battery in a radial direction of the tube.

9. The system according to claim 8, wherein a thickness of a wall of each tube of the plurality of tubes is less than 10% of a diameter of said tube.

10. The system according to claim 1, wherein a thickness of a wall of each tube of the plurality of tubes is less than 10% of a diameter of said tube.

11. The system according to claim 1, wherein a thickness of each tube of the plurality of tubes is in a range of from 1.5 mm to 4 mm, and
wherein a diameter of each tube of the plurality of tubes is in a range of from 45 mm to 60 mm.

12. A method for protecting a battery pack, the method comprising:
providing the system according to claim 1; and
disposing the plurality of tubes around batteries, respectively, of the battery pack.

13. The method according to claim 12, wherein the disposing of the plurality of tubes around the batteries, respectively, of the battery pack comprises disposing the plurality of tubes such that the PCM of each tube is in direct physical contact with the respective battery around which the tube is disposed.

14. A system for protecting batteries, the system comprising:
a plurality of tubes configured to be disposed around the batteries, respectively,
wherein each tube of the plurality of tubes comprises a phase change material (PCM) disposed therein, and
wherein the PCM comprises a paraffin-graphite composite.

15. The system according to claim 12, wherein a weight ratio of graphite:paraffin in the PCM is about 1:15.

16. The system according to claim 12, wherein each tube of the plurality of tubes is a cylindrical-shaped tube, and
wherein each tube of the plurality of tubes is completely filled with the PCM in an axial direction of the tube and completely filled with PCM around the battery in a radial direction of the tube.

17. The system according to claim 12, wherein a thickness of a wall of each tube of the plurality of tubes is less than 10% of a diameter of said tube.

18. The system according to claim 12, wherein a thickness of each tube of the plurality of tubes is in a range of from 1.5 mm to 4 mm, and
wherein a diameter of each tube of the plurality of tubes is in a range of from 45 mm to 60 mm.

19. A method for dissipating heat from a battery pack, the method comprising:
providing the system according to claim 12; and
disposing the plurality of tubes around batteries, respectively, of the battery pack.

20. The method according to claim 19, wherein the disposing of the plurality of tubes around the batteries, respectively, of the battery pack comprises disposing the plurality of tubes such that the PCM of each tube is in direct physical contact with the respective battery around which the tube is disposed.
